(19) United States
(12) Patent Application Publication
(10) Pub. No.: US 2020/0250183 A1
(43) Pub. Date: Aug. 6, 2020

(54) INFORMATION PROCESSING APPARATUS ACCESSIBLE TO MULTIPLE DATABASES AND DISPLAYING SEARCH RESULTS ON DISPLAY APPARATUS

(71) Applicant: Panasonic Intellectual Property Management Co., Ltd., Osaka (JP)

(72) Inventors: Taishi ASANO, Osaka (JP); Kenji TACHIBANA, Osaka (JP); Shunsuke SAITO, Osaka (JP); Masaharu HIROHATA, Osaka (JP); Masashi SETO, Osaka (JP); Tetsuya URIMOTO, Osaka (JP); Ryota TSUKIDATE, Osaka (JP); Tomoko ISHIKAWA, Osaka (JP)

(21) Appl. No.: 16/850,189

(22) Filed: Apr. 16, 2020

Related U.S. Application Data
(63) Continuation of application No. PCT/JP2018/037397, filed on Oct. 5, 2018.
(60) Provisional application No. 62/573,344, filed on Oct. 17, 2017.

(51) Int. Cl. G06F 16/2455; G06F 3/0484; H04W 4/02; H04W 4/40; G06F 16/27

(52) U.S. Cl. CPC G06F 16/2455; G06F 3/0484; G06F 16/27; H04W 4/40; H04W 4/023

(57) ABSTRACT

An information processing apparatus accesses to a plurality of databases. The information processing apparatus accesses one of the plurality of databases, and based on an access result, accesses another one of the plurality of databases.

This is a continuation application of International Application No. PCT/JP2018/037397, with an international filing date of Oct. 5, 2018, which claims priority of U.S. provisional application No. 62/573,344 filed on Oct. 17, 2017, the content of which is incorporated herein by reference.

### BACKGROUND

### 1. Technical Field

The present disclosure relates to an information processing apparatus accessible to a plurality of databases, and for example, to be mounted on a moving body, such as a vehicle.

### 2. Description of Related Art

In order to handle certain types of tasks, accesses to a plurality of databases may be required. For example, when handling an emergency call to the police, a police officer or a police vehicle accesses a database storing information on a reported incident or accident (see, for example, Japanese Patent Laid-open Publication No. JP H11-120494 A), and obtains a route from a current position to a scene at which the incident or accident occurs. If necessary, the police officer further accesses a database storing other information on the incident or accident (for example, stolen vehicles and/or ex-convicts, etc.).

### SUMMARY

For example, the police officer may operate a terminal apparatus for accessing the plurality of databases, while driving the vehicle, in order to obtain necessary information while moving to the scene at which the incident or accident occurs. In such a case, safety may be threatened. Therefore, it is necessary to simplify operation of searching for and displaying information stored in the plurality of databases.

One non-limiting and exemplary embodiment provides an information processing apparatus capable of accessing a plurality of databases with simple operation.

According to an aspect of the present disclosure, an information processing apparatus is provided, which is accessible to a plurality of databases, and the information processing apparatus accesses one of the plurality of databases, and based on an access result, accesses another one of the plurality of databases.

Additional benefits and advantages of the disclosed embodiments will be apparent from the specification and Figures. The benefits and/or advantages may be individually provided by the various embodiments and features of the specification and drawings disclosure, and need not all be provided in order to obtain one or more of the same.

According to the aspect of the present disclosure, the information processing apparatus can access a plurality of databases with simple operation.

### BRIEF DESCRIPTION OF DRAWINGS

FIG. 1 is a block diagram illustrating a configuration of a navigation system including an information processing apparatus according to a first embodiment;

FIG. 2 is a diagram illustrating an exemplary arrangement of a control apparatus 11, display apparatuses 12 and 13, and a keypad 17 of FIG. 1;

FIG. 3 is a block diagram illustrating a configuration of the control apparatus 11 of FIG. 1;

FIG. 4 is a schematic diagram illustrating an architecture of programs to be executed by the control apparatus 11 of FIG. 1;

FIG. 5 is a state transition diagram illustrating operations of the control apparatus 11 of FIG. 1;

FIG. 6 is a sequence diagram illustrating an exemplary operation of the navigation system of FIG. 1, when an incident is assigned to a vehicle 1 of FIG. 1;

FIG. 7 is a sequence diagram illustrating another exemplary operation of the navigation system of FIG. 1, when an incident is assigned to the vehicle 1 of FIG. 1;

FIG. 8 is a sequence diagram illustrating an exemplary operation of the navigation system of FIG. 1, when a message destined for the vehicle 1 of FIG. 1 is inputted;

FIG. 9 is a sequence diagram illustrating an exemplary operation of the navigation system of FIG. 1, when cancelling an incident assigned to the vehicle 1 of FIG. 1;

FIG. 10 is a sequence diagram illustrating an exemplary operation of the navigation system of FIG. 1, when searching for information on a target vehicle, in the vehicle 1 of FIG. 1;

FIG. 11 is a diagram illustrating an exemplary image to be displayed on the display apparatus 13 of FIG. 1, when the control apparatus 11 of FIG. 1 is in normal mode;

FIG. 12 is a diagram illustrating an exemplary image to be displayed on the display apparatus 13 of FIG. 1, when the control apparatus 11 of FIG. 1 is in the normal mode and an incident is assigned to the vehicle 1;

FIG. 13 is a diagram illustrating an exemplary image to be displayed on the display apparatus 13 of FIG. 1, when the control apparatus 11 of FIG. 1 is in navigation mode and the vehicle 1 is moving to a scene of an incident;

FIG. 14 is a diagram illustrating an exemplary image to be displayed on the display apparatus 13 of FIG. 1, when the control apparatus 11 of FIG. 1 is in the navigation mode and the vehicle 1 has arrived at the scene of the incident;

FIG. 15 is a diagram illustrating an exemplary image to be displayed on the display apparatus 13 of FIG. 1, when the control apparatus 11 of FIG. 1 is in person information mode;

FIG. 16 is a diagram illustrating an exemplary image to be displayed on the display apparatus 13 of FIG. 1, when the control apparatus 11 of FIG. 1 is in the navigation mode and a message destined for the vehicle 1 is inputted;

FIG. 17 is a diagram illustrating an exemplary image to be displayed on the display apparatus 13 of FIG. 1, when an incident assigned to the vehicle 1 is canceled;

FIG. 18 is a diagram illustrating an exemplary image to be displayed on the display apparatus 13 of FIG. 1, when no incident is assigned to the vehicle 1;

FIG. 19 is a diagram illustrating an exemplary image to be displayed on the display apparatus 13 of FIG. 1, when the control apparatus 11 of FIG. 1 is in vehicle search mode and waits for a user input;

FIG. 20 illustrates an exemplary image to be displayed on the display apparatus 13 of FIG. 1, when the control apparatus 11 of FIG. 1 is in the vehicle search mode and indicates that a target vehicle corresponding to a search key is not stolen;

FIG. 21 illustrates an exemplary image to be displayed on the display apparatus 13 of FIG. 1, when the control apparatus 11 of FIG. 1 is in the vehicle search mode and indicates that the target vehicle corresponding to the search key is stolen;

FIG. 22 is a diagram illustrating an exemplary image to be displayed on the display apparatus 13 of FIG. 1, when the control apparatus 11 of FIG. 1 is in the vehicle search mode and there is no target vehicle corresponding to the search key;

FIG. 23 is a flowchart illustrating an on-scene process to be executed by the control apparatus 11, when the vehicle 1 of FIG. 1 has arrived at the scene of the incident;

FIG. 24 is a block diagram illustrating a configuration of a navigation system including an information processing apparatus according to a second embodiment;

FIG. 25 is a sequence diagram illustrating an exemplary operation of the navigation system of FIG. 24, when an incident is assigned to a vehicle 1 of FIG. 24;

FIG. 26 is a sequence diagram illustrating another exemplary operation of the navigation system of FIG. 24, when an incident is assigned to the vehicle 1 of FIG. 24;

FIG. 27 is a sequence diagram illustrating an exemplary operation of the navigation system of FIG. 24, when a message destined for the vehicle 1 of FIG. 24 is inputted;

FIG. 28 is a sequence diagram illustrating an exemplary operation of the navigation system of FIG. 24, when cancelling an incident assigned to the vehicle 1 of FIG. 24; and

FIG. 29 is a sequence diagram illustrating an exemplary operation of the navigation system of FIG. 24, when searching for information on a target vehicle, in the vehicle 1 of FIG. 24.

### DETAILED DESCRIPTION

Hereinafter, embodiments will be described in detail with reference to the drawings as appropriate. However, excessively detailed explanation may be omitted. For example, detailed explanation of well-known matters may be omitted, and redundant explanations on substantially the same configuration may be omitted. This is to avoid the unnecessary redundancy of the following description, and to facilitate understanding by those skilled in the art.

It is to be noted that the applicant intends to provide the accompanying drawings and the following description so that those skilled in the art can sufficiently understand the present disclosure, and does not intend to limit subject matters recited in the claims.

### First Embodiment

Hereinafter, with reference to the drawings, a navigation system including an information processing apparatus according to a first embodiment will be described.

[1. Overall Configuration]

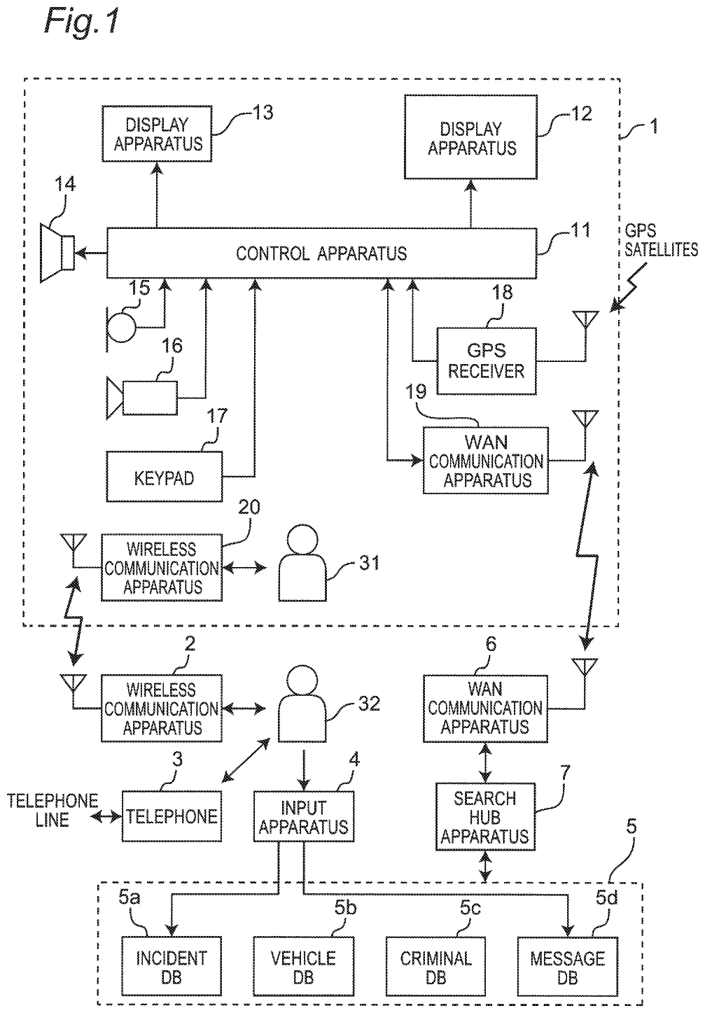

FIG. 1 is a block diagram illustrating a configuration of the navigation system including the information processing apparatus according to the first embodiment. The navigation system of FIG. 1 includes: one or a plurality of vehicles 1, a wireless communication apparatus 2, a telephone 3, an input apparatus 4, server apparatuses 5, a WAN communication apparatus 6, and a search hub apparatus 7. In the embodiment, for example, the vehicle 1 is a patrol car, and the wireless communication apparatus 2, the telephone 3, the input apparatus 4, the server apparatuses 5, the WAN communication apparatus 6, and the search hub apparatus 7 are located in a police's dispatch center, or the like. The vehicle 1 is driven by a police officer 31, and the components of the vehicle 1 as shown in FIG. 1 are operated by the same police officer 31. The wireless communication apparatus 2, the telephone 3, and the input apparatus 4 are operated by an operator 32 in the dispatch center.

[1-1. Configuration of Vehicle 1]

The vehicle 1 is provided with: a control apparatus 11, display apparatuses 12 and 13, a speaker 14, a microphone 15, a camera 16, a keypad 17, a GPS receiver 18, a WAN communication apparatus 19, and a wireless communication apparatus 20.

The control apparatus 11 controls operations of the components of the vehicle 1, except for the wireless communication apparatus 20.

The display apparatus 12 displays images generated by the control apparatus 11. The display apparatus 12 has a screen of, for example, but not limited thereto, 10 to 15 inches, or may have a screen of a larger or smaller size.

The display apparatus 13 also displays images generated by the control apparatus 11. The display apparatus 13 has a screen smaller than the screen of the display apparatus 12, and is disposed in the vehicle 1 so as to occupy a predetermined angular range or less of a visual field in front of a driver of the vehicle 1 (i.e., the police officer 31 driving the vehicle 1). Accordingly, the police officer 31 driving the vehicle 1 can view the screen of the display apparatus 13, without moving a line of sight from the front of the vehicle 1.

The speaker 14 outputs alarm sounds or the like, generated by the control apparatus 11.

The microphone 15 obtains voice commands or the like, spoken by the police officer 31.

The camera 16 captures images around the vehicle 1. The camera 16 may be one omnidirectional camera, or may be a plurality of cameras with different fields of view, or may be one or more cameras steered by a driving mechanism.

The keypad 17 includes a few buttons with noticeable sizes, near a steering wheel of the vehicle 1, such that the police officer 31 driving the vehicle 1 can operate the keypad 17 without largely moving the line of sight from the front of the vehicle 1.

The GPS receiver 18 receives GPS signals from Global Positioning System (GPS) satellites. The control apparatus 11 determines a position of the vehicle 1 based on the GPS signals. Note that, as long as the control apparatus 11 can determine the position of the vehicle 1, it is possible to utilize any positioning system, including a global satellite positioning system, or a satellite positioning system using quasi-zenith satellites, besides the GPS.

The WAN communication apparatus 19 is connected to the WAN communication apparatus 6 in the dispatch center, via a wireless wide area network (WAN), such as Long Term Evolution (LTE), and the Internet.

Accordingly, the control apparatus 11 is connected to the server apparatuses 5 via the WAN communication apparatus 19, the WAN communication apparatus 6, and the search hub apparatus 7. Note that, as long as the control apparatus 11 is connected to the server apparatuses 5 via the search hub apparatus 7, it is possible to utilize any communication scheme, besides LTE.

The wireless communication apparatus 20 is connected to the wireless communication apparatus 2 in the dispatch center via, for example, a police radio network. Accordingly, the police officer 31 talks with the operator 32 via the wireless communication apparatus 20 and the wireless communication apparatus 2. The wireless communication apparatus 20 may be independent of the other components of the vehicle 1 as shown in FIG. 1.

The components of the vehicle 1, except for the control apparatus 11 and the wireless communication apparatus 20, may be connected to the control apparatus 11 in a wired or wireless manner. In the case of the wired connection, the components of the vehicle 1 may be directly connected to the control apparatus 11, or may be connected to the control apparatus 11 via a hub apparatus. For example, the display apparatus 13, the speaker 14, the microphone 15, the camera 16, and the keypad 17 may be connected to the control apparatus 11 via, for example, a Universal Serial Bus (USB) hub apparatus. The display apparatus 13 may have, for example, an input terminal of High Definition Multimedia Interface (HDMI) (registered trademark), and in this case, the display apparatus 13 may be connected to the control apparatus 11 via an HDMI/USB conversion adapter.

The control apparatus 11 may be a notebook-type or tablet-type portable personal computer. In this case, the display apparatus 12 is integrated with the control apparatus 11. The control apparatus 11 is, for example, TOUGHBOOK (registered trademark) or TOUGHPAD (registered trademark) of Panasonic Corporation. In addition, at least a part of the speaker 14, the microphone 15, the GPS receiver 18, and the WAN communication apparatus 19 may also be integrated with the control apparatus 11.

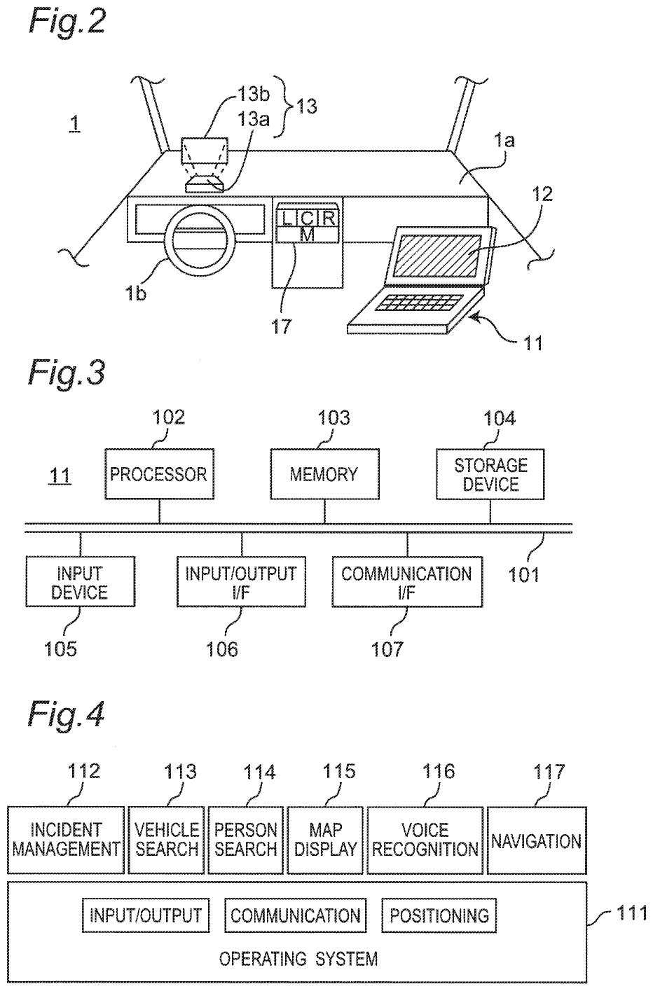

FIG. 2 is a diagram illustrating an exemplary arrangement of the control apparatus 11, the display apparatuses 12 and 13, and the keypad 17 of FIG. 1. FIG. 2 illustrates a case where the control apparatus 11 is a notebook-type portable personal computer, and the display apparatus 12 is integrated with the control apparatus 11. In addition, in the example of FIG. 2, the display apparatus 13 is a head-up display provided with: a projector 13a, and a small and translucent screen 13b. The display apparatus 13 has the screen smaller than the screen of the display apparatus 12, and is disposed on an upper surface 1a of a dashboard of the vehicle 1 so as to occupy the predetermined angular range or less of the visual field in front of the police officer 31 driving the vehicle 1. In addition, in the example of FIG. 2, the keypad 17 includes an “L” button, a “C” button, an “R” button, and an “M” button, and is provided near the steering wheel 1b of the vehicle 1. A signal generated by each button of the keypad 17 emulates a key code.

In the example of the embodiment, the “M” button switches among modes (described below) of the control apparatus 11. In addition, in the example of the embodiment, the “L” button, the “C” button, and the “R” button have predetermined functions variable depending on a status of the control apparatus 11. In addition, for example, by long pressing the “L” button, the last is canceled. In addition, for example, by pressing the “C” button twice in succession, the voice commands are made available. For example, by speaking “Return” or “Back”, the last operation is canceled.

The control apparatus 11 may be detachably connected to a mounting apparatus fixed to the vehicle 1. The mounting apparatus for the control apparatus 11 may have interfaces for connecting the control apparatus 11 to other components (excluding the wireless communication apparatus 20) of the vehicle 1 as shown in FIG. 1. In addition, the mounting apparatus for the control apparatus 11 may have an interface for receiving power supplied from a battery of the vehicle 1. Before supplying a voltage of the battery of the vehicle 1 to the mounting apparatus for the control apparatus 11, the voltage may be converted into a desired voltage (for example, an operating voltage of the portable personal computer) by, for example, a power conversion apparatus provided by Lind Electronics, Inc.

The display apparatus 13 may be detachably connected to a mounting apparatus fixed to the vehicle 1. The mounting apparatus for the display apparatus 13 may have an interface for receiving power supplied from the battery of the vehicle 1.

In the present specification, the components of the vehicle 1, except for the wireless communication apparatus 20, but including at least the control apparatus 11, are also referred to as an “information processing apparatus”. In addition, in the present specification, the control apparatus 11 is also referred to as a “control unit”, the display apparatus 13 is also referred to as a “display unit”, the GPS receiver 18 is also referred to as a “positioning unit”, and the WAN communication apparatus 19 is also referred to as a “communication unit”.

[1-2. Configuration of Dispatch Center]

As described above, the wireless communication apparatus 2, the telephone 3, the input apparatus 4, the server apparatuses 5, the WAN communication apparatus 6, and the search hub apparatus 7 are provided, for example, in the police's dispatch center.

Again referring to FIG. 1, the wireless communication apparatus 2 is connected to the wireless communication apparatus 20 of the vehicle 1 via, for example, the police radio network, as described above.

The telephone 3 is connected to a telephone line of a public switched telephone network. The operator 32 receives a call (report) about an incident (or accident) via the telephone 3. The operator 32 inputs details of the reported incident to an incident database (DB) of a server apparatus 5a, described below, via the input apparatus 4. Further, the operator 32 assigns the reported incident to a person(s) (i.e., the police officer 31 or the vehicle 1), and inputs the assignment to the incident database (DB) via the input apparatus 4.

The server apparatuses 5 include server apparatuses 5a to 5d that store an incident database, a criminal database, a vehicle database, and a message database, respectively.

The incident database stores information on the reported incidents (referred to as “incident information”). The incident information includes an address of a scene at which an incident occurs. In other words, the incident database stores information on a plurality of tasks (incidents) each associated with a predetermined destination (scene of the incident). The incident database stores, for example, information on the following items for each incident.

### Incident Database

A1: Person(s) in charge assigned to incident (i.e., police officer(s) or vehicle)
A2: Time when incident occurs
A3: Address of scene at which incident occurs
A4: Type of incident
A5: Details of incident
A6: Status of incident (i.e., whether or not incident is assigned to person(s))

The vehicle database stores information on a plurality of vehicles to each of which a vehicle registration number is given (hereinafter, referred to as “vehicle information”). The vehicle database stores, for example, information on the following items for each vehicle.

### Vehicle Database

B1: Vehicle identification number (VIN)
B2: Vehicle registration number
B3: Registration date or renewal date of vehicle registration number
B4: Expiration date of vehicle registration number
B5: Owner of vehicle
B6: Model of vehicle
B7: Manufacturer of vehicle
B8: Model year of vehicle
B9: Color of vehicle
B10: State that issued vehicle registration number
B11: Status of vehicle (whether or not vehicle is stolen)

The criminal database stores information on a plurality of persons each having a previous criminal record (referred to as “person information”). The criminal database stores, for example, information on the following items for each person.

### Criminal Database

### C1: Name

### C2: Address

C3: Date of birth

### C4: Sex

### C5: Height

### C6: Race

C7: Face photograph
C8: details of previous criminal record
C9: Status (whether or not criminal is wanted)

The message database stores messages destined for vehicles 1 from the operator 32 of the police dispatch center. The operator 32 inputs contents of the messages into the message database via the input apparatus 4. The messages may include, for example, additional information on the incidents. The message database stores, for example, information on the following items for each vehicle 1 (i.e., for each destination).

### Message Database

D1: Destination of message
D2: Time when message is inputted
D3: Message body

In the present specification, the incident database, the criminal database, the vehicle database, and the message database are also referred to as “external databases”.

Note that, the items of the information stored in the incident database, the vehicle database, the criminal database, and the message database are not limited to those described above, and may not include some items, or may include other additional information.

The incident database may be built using Computer Aided Dispatch (CAD) software provided by third party vendors. In addition, when the navigation system of the embodiment is used in the United States, the criminal database may include databases of the Criminal Justice Information Service (CJIS), the National Crime Information Center (NCIC), and the Integrated Automated Fingerprint Identification System (IAFIS) of the Federal Bureau of Investigation of the United States, or may include the Defense Data Exchange (D-Dex) of Unite States Department of Defense. The vehicle database may include vehicle information on only the stolen vehicles.

The server apparatuses 5a to 5d may be provided in one site, or may be provided in a plurality of different sites. In addition, at least two of the incident database, the criminal database, the vehicle database, and the message database may be provided in the same server apparatus.

In addition, the databases stored in the server apparatuses 5 are not limited to a set of the incident database, the vehicle database, the criminal database, and the message database, and may not include some databases, or may include other additional databases.

The input apparatus 4 is, for example, a terminal apparatus, including a keyboard, a pointing device, a display apparatus, and the like. The operator 32 can browse all incidents stored in the incident database of the server apparatus 5a, using such a terminal apparatus.

The WAN communication apparatus 6 is connected to the WAN communication apparatus 19 of the vehicle 1 via a wireless WAN, such as LTE, and the Internet, as described above.

The search hub apparatus 7 is communicatively connected to the control apparatus 11 and the server apparatuses 5a to 5d, searches for the information stored in the server apparatuses 5a to 5d, and transmits search results to the control apparatus 11. Accordingly, the control apparatus 11 is communicatively connected to the server apparatuses 5a to 5d in an indirect manner via the search hub apparatus 7.

[1-3. Detailed Configuration of Control Apparatus 11)

FIG. 3 is a block diagram illustrating a configuration of the control apparatus 11 of FIG. 1. The control apparatus 11 is provided with: a bus 101, a processor 102, a memory 103, a storage device 104, an input device 105, an input/output interface (I/F) 106, and a communication interface (I/F) 107. The processor 102, the memory 103, the storage device 104, the input device 105, the input/output interface 106, and the communication interface 107 are connected to each other via the bus 101. The storage device 104 is, for example, a solid state drive or a hard disk drive, and persistently stores programs described below with reference to FIG. 4. The processor 102 reads the programs stored in the storage device 104, into the memory 103, and executes the programs. The input device 105 includes a keyboard and a pointing device. The input/output interface 106 is, for example, USB, and is connected to the display apparatuses 12 and 13, the speaker 14, the microphone 15, the camera 16, and the keypad 17 of FIG. 1. The communication interface 107 is connected to the GPS receiver 18 and the WAN communication apparatus 19 of FIG. 1.

FIG. 4 is a schematic diagram illustrating the architecture of programs to be executed by the control apparatus 11 of FIG. 1. The processor 102 of the control apparatus 11 executes a program of an operating system 111. The operating system 111 provides an Application Programming Interface (API) for accessing the input/output interface 106, provides an API for accessing and communicating with the WAN communication apparatus 19, and provides an API for accessing the GPS receiver 18 and positioning. For example, the operating system 111 includes an event listener as a service that detects a press of any button of the keypad 17 and the input device 105, and an input of a voice command. The operating system 111 is, for example, a 64-bit version of Windows (registered trademark) 10, or a 32-bit or 64-bit version of Windows 7 of Microsoft Corporation.

In addition, the processor 102 executes, on the operating system 111, programs of an incident management application 112, a vehicle search application 113, a person search application 114, a map display application 115, a voice recognition application 116, and a navigation application 117.

The incident management application 112 communicates with the search hub apparatus 7, receives incident information on an incident assigned to the vehicle 1, from the search hub apparatus 7, and displays the received incident information, on the display apparatus 12. The police officer 31 controls operations of the incident management application 112 (editing the incident information, scrolling a displayed content, etc.), using the input device 105.

The vehicle search application 113 communicates with the search hub apparatus 7, receives vehicle information on a target vehicle associated with a certain vehicle registration number, from the search hub apparatus 7, and displays the received vehicle information, on the display apparatus 12. The police officer 31 controls operations of the vehicle search application 113 (inputting a search key, scrolling a display content, etc.), using the input device 105.

The person search application 114 communicates with the search hub apparatus 7, receives person information on an ex-convict associated with a certain address, from the search hub apparatus 7, and displays the received person information, on the display apparatus 12. The police officer 31 controls operations of the person search application 114 (inputting a search key, scrolling a display content, etc.), using the input device 105.

The map display application 115 displays a map near a current position of the vehicle 1, on the display apparatus 12 and/or 13. In addition, the map display application 115 displays, on the display apparatus 12 and/or 13, a route from the current position of the vehicle 1 to a scene at which the incident assigned to the vehicle 1 occurs.

The voice recognition application 116 receives search keys and other user inputs, inputted by voice. The voice recognition application 116 is, for example, Dragon Law Enforcement provided by Nuance Communications, Inc.

The navigation application 117 has a part of the functions of the incident management application 112, a part of the functions of the vehicle search application 113, and a part of the functions of the person search application 114. The navigation application 117 communicates with the search hub apparatus 7, receives incident information on an incident assigned to the vehicle 1, from the search hub apparatus 7, and displays the received incident information, on the display apparatus 13. In addition, the navigation application 117 communicates with the search hub apparatus 7, receives vehicle information on a vehicle associated with a certain vehicle registration number, from the search hub apparatus 7, and displays the received vehicle information, on the display apparatus 13. In addition, the navigation application 117 communicates with the search hub apparatus 7, receives person information on an ex-convict associated with a certain address, from the search hub apparatus 7, and displays the received person information, on the display apparatus 13. The police officer 31 controls operations of the navigation application 117 using the keypad 17 and the microphone 15. The navigation application 117 uses the voice recognition application 116 to receive the search keys and other user inputs, inputted by voice.

The incident management application 112, the vehicle search application 113, the person search application 114, and the navigation application 117 are activated, for example, using the input device 105. The activation of the navigation application 117 may be restricted such that multiple instances of the navigation application 117 are not simultaneously executed.

The navigation application 117 is executed in parallel with the incident management application 112, the vehicle search application 113, and the person search application 114.

Hereinafter, operations of the control apparatus 11 by executing the program of the navigation application 117 will be described in detail.

[2. Operations]

As described above, the control apparatus 11 displays the incident information, the vehicle information, and the person information, on the display apparatus 12, and also displays the route from the current position of the vehicle 1 to the scene at which the incident assigned to the vehicle 1 occurs, on the display apparatus 12. As described above, since the incident information, the vehicle information, and the person information include various items, the user needs to concentrate on the screen of the display apparatus 12 and operate the input device 105, in order to browse the information and the route. If the user views the screen of the display apparatus 12 or operates the input device 105 while driving the vehicle 1, then safety may be threatened. For example, suppose that the display apparatus 12 is turned off while driving for the sake of safety, it is inefficient to stop the vehicle 1 whenever the user wishes to browse the incident information, the vehicle information, the person information, and the map. Therefore, it is necessary to browse the incident information, the vehicle information, the person information, and the map, with simple operation. Hereinafter, we will describe operations of the control apparatus 11 and the navigation system according to the embodiment that solve this problem.

[2-1. State Transition of Control Apparatus 11]

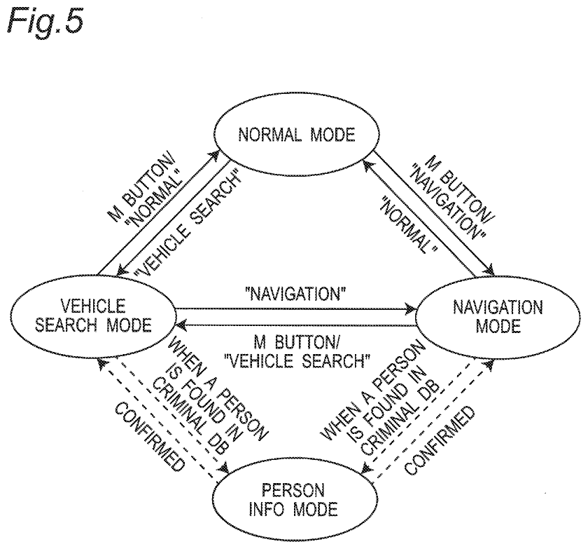

FIG. 5 is a state transition diagram illustrating the operations of the control apparatus 11 of FIG. 1. When executing the program of the navigation application 117, the control apparatus 11 has a normal mode, a navigation mode, a vehicle search mode, and a person information mode.

In the normal mode, the control apparatus 11 displays the map indicating the current position of the vehicle 1 (i.e., the control apparatus 11), on the display apparatus 13.

In the navigation mode, the control apparatus 11 displays, on the display apparatus 13, an image and/or text for directing a route from the current position of the vehicle 1 to a destination (i.e., a scene of an incident) associated with a task (i.e., the incident) assigned to the vehicle 1.

In the vehicle search mode, the control apparatus 11 displays information on the target vehicle associated with the vehicle registration number, on the display apparatus 13.

In the person information mode, when a person associated with the destination address exists and satisfies predetermined conditions, or when a person who is the owner of the target vehicle satisfies predetermined conditions, the control apparatus 11 displays information on that person, on the display apparatus 13. In the example of the embodiment, the conditions are that the person has a serious previous criminal record, such as gun or drug.

In the present specification, the “navigation mode” is also referred to as a “first mode”, the “vehicle search mode” is also referred to as a “second mode”, the “person information mode” is also referred to as a “third mode”, and the “normal mode” is also referred to as a “fourth mode”.

In the example of the embodiment, the control apparatus 11 transitions among these modes as follows.

In a case where the control apparatus 11 is in the normal mode, when the “M” button is pressed, or when the voice command “Navigation” is spoken, the control apparatus 11 transitions to the navigation mode. In addition, in the case where the control apparatus 11 is in the normal mode, when the voice command “Vehicle Search” is spoken, the control apparatus 11 transits to the vehicle search mode.

In a case where the control apparatus 11 is in the navigation mode, when the “M” button is pressed, or when the voice command “Vehicle Search” is spoken, the control apparatus 11 transitions to the vehicle search mode. In addition, in the case where the control apparatus 11 is in the navigation mode, when the voice command “Normal” is spoken, the control apparatus 11 transitions to the normal mode.

In a case where the control apparatus 11 is in the vehicle search mode, when the “M” button is pressed, or when the voice command “Normal” is spoken, the control apparatus 11 transitions to the normal mode. In addition, in the case where the control apparatus 11 is in the vehicle search mode, when the voice command “Navigation” is spoken, the control apparatus 11 transitions to the navigation mode.

In the case where the control apparatus 11 is in the navigation mode, when an ex-convict associated with the address of the scene at which the incident assigned to the vehicle 1 occurs is found in the criminal database of the server apparatus 5c, the control apparatus 11 transitions to the person information mode. In the case where the control apparatus transitions from the navigation mode to the person information mode, when any button of the keypad 17 indicating confirmation (for example, “L” button) is pressed, or when the voice command “Confirmed” is spoken, the control apparatus 11 returns to the navigation mode.

In the case where the control apparatus 11 is in the vehicle search mode, when an ex-convict who is the owner of the vehicle 1 is found in the criminal database of the server apparatus 5c, the control apparatus 11 transitions to the person information mode. In the case where the control apparatus transitions from the vehicle search mode to the person information mode, when any button of the keypad 17 indicating confirmation (for example, “L” button) is pressed, or when the voice command “Confirmed” is spoken, the control apparatus 11 returns to the vehicle search mode.

In the example of FIG. 5, each time the “M” button is pressed, the control apparatus 11 sequentially transitions among these modes, in the order of the normal mode, the navigation mode, and the vehicle search mode. In addition, when the control apparatus has transitioned from the navigation mode to the person information mode, the control apparatus 11 may return to the navigation mode in response to pressing of the “M” button. In addition, when the control apparatus has transitioned from the vehicle search mode to the person information mode, the control apparatus 11 may return to the vehicle search mode in response to pressing of the “M” button.

Instead of the voice command “Navigation”, any predetermined voice command, “My Call” or the like, may be used. Instead of the voice command “Vehicle Search”, any predetermined voice command, “Number Plate”, “License Plate”, “Run Plate” or the like, may be used. Instead of the voice command “Normal”, any predetermined voice command, “map” or the like, may be used.

Hereinafter, we will describe detailed operations of the control apparatus 11 and the navigation system in the normal mode, the navigation mode, the vehicle search mode, and the person information mode.

[2-2. Normal Mode]

When the control apparatus 11 executes the navigation application 117, the control apparatus 11 initially enters the normal mode. In the normal mode, the control apparatus 11 displays the map indicating the current position of the vehicle 1, on the display apparatus 13, as described above.

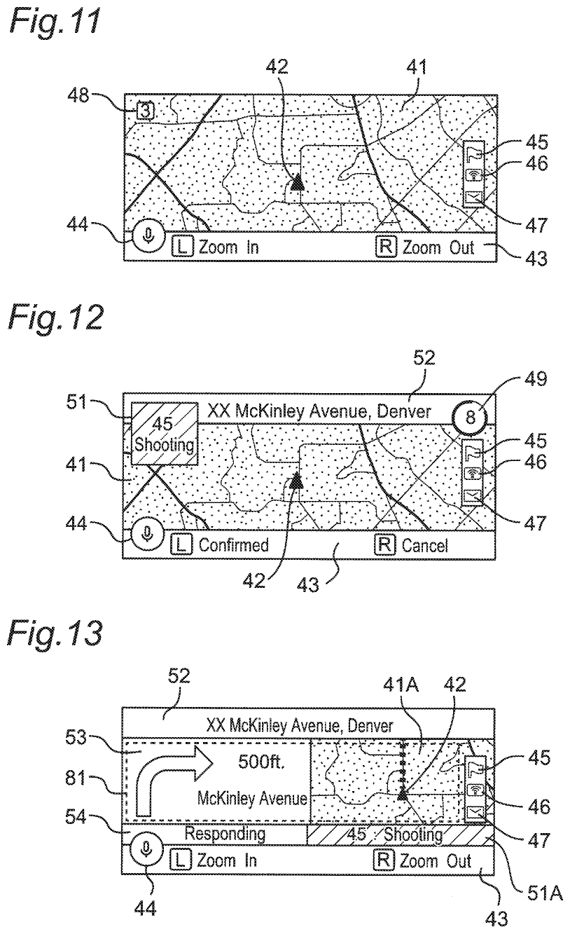

FIG. 11 is a diagram illustrating an exemplary image to be displayed on the display apparatus 13 of FIG. 1, when the control apparatus 11 of FIG. 1 is in the normal mode. In the state of FIG. 11, the entire image to be displayed on the display apparatus 13 includes: a map 41, a current position 42 of the vehicle 1, a footer region 43, a voice recognition icon 44, a flag icon 45, a wireless connection icon 46, a message icon 47, and a counter icon 48.

The map 41 illustrates the vicinity of the vehicle 1. The content of the displayed map 41 is updated, for example, every three seconds. An orientation of the vehicle 1 is calculated based on a history of positioning. The map 41 is displayed such that, for example, the front of the vehicle 1 faces upward in the map. Alternatively, the map 41 may be displayed such that north is at the top of the map. The orientation and update frequency of the map 41 can be set, for example, using a configuration file (for example, a file with an extension “.ini”) stored in the storage device 104 of the control apparatus 11. In addition, the scale of the map 41 can be changed. The latest value is stored as a default scale of the map 41.

The footer region 43 describes the functions of the “L” button, the “C” button, and the “R” button. In the example of FIG. 11, the “L” button is set to enlarge the map 41, and the “R” button is set to reduce the map 41. In addition, in the example of FIG. 11, no function is set to the “C” button.

The voice recognition icon 44 indicates whether or not the voice commands are available. For example, the voice recognition icon 44 indicates that the voice commands are not available when a diagonal line is drawn thereon, and the voice commands are available when no diagonal line is drawn thereon. The voice recognition icon 44 may further indicate whether or not the spoken voice command has been recognized. For example, the voice recognition icon 44 indicates that the voice command has not been recognized when the voice recognition icon 44 is red, and the voice command has been recognized when the voice recognition icon 44 is green. The police officer 31 may, for example, speak a voice command “Zoom In” to enlarge the map 41, and may speak a voice command “Zoom Out” to reduce the map 41.

The flag icon 45 indicates that an incident is assigned to the vehicle 1. The wireless connection icon 46 indicates that the vehicle 1 can communicate via the WAN communication apparatus 19. The message icon 47 indicates that a message destined for the vehicle 1 is received from the message database of the server apparatus 5d.

The counter icon 48 indicates the number of incidents being assigned to the vehicle 1 and pending.

[2-3. Navigation Mode]

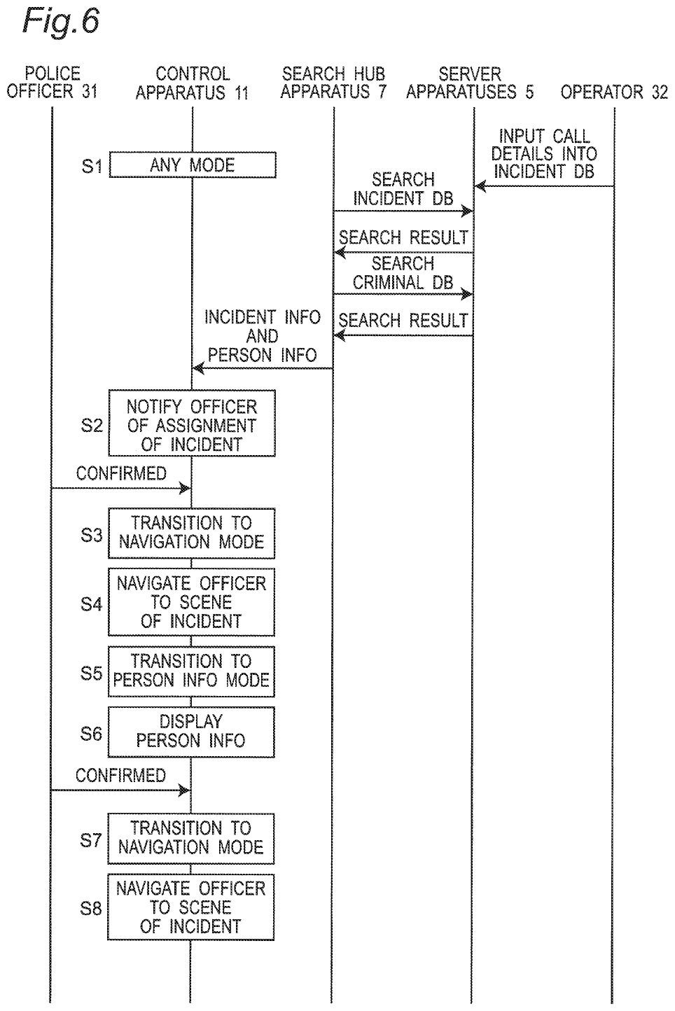

FIG. 6 is a sequence diagram illustrating an exemplary operation of the navigation system of FIG. 1, when the incident is assigned to the vehicle 1 of FIG. 1.

In step S1, the control apparatus 11 is in any mode of the normal mode, the navigation mode, the vehicle search mode, and the person information mode.

When receiving an incident or accident call, the operator 32 inputs call details into items of the incident database of the server apparatus 5a (for example, items A1 to A4).

The search hub apparatus 7 automatically and periodically (for example, every few seconds) searches the incident database of the server apparatus 5a, and when a new incident has been inputted, receives a search result. In addition, the search hub apparatus 7 automatically searches the criminal database of the server apparatus Sc based on the search result of the server apparatus 5a, that is, an address of a scene at which a new incident has occurred, and receives a search result including person information on a person associated with this address. When there is an incident assigned to the vehicle 1, the search hub apparatus 7 automatically and periodically transmits the incident information on the incident, to the control apparatus 11 of the vehicle 1. The transmitted incident information may include only items A3 to A4 to be displayed on the display apparatus 13 as described below, and may further include other items stored in the incident database. If there is person information on an ex-convict associated with the address of the scene at which the incident occurs, then the search hub apparatus 7 transmits the person information as well as the incident information. The transmitted person information may include only items C1, C2, C7, and C8 to be displayed on the display apparatus 13 as described below, and may further include other items stored in the criminal database.

If the incident information (or the incident information and the person information) is received from the search hub apparatus 7, then in step S2, the control apparatus 11 displays, on the display apparatus 13, a message indicating that the incident is assigned to the vehicle 1 on which the control apparatus 11 is mounted.

FIG. 12 is a diagram illustrating an exemplary image to be displayed on the display apparatus 13 of FIG. 1, when the control apparatus 11 of FIG. 1 is in the normal mode and an incident is assigned to the vehicle 1. In the state of FIG. 12, the entire image to be displayed on the display apparatus 13 includes: a timer icon 49, an incident identifier 51, and a destination address 52, which are overlaid on the elements of the image of FIG. 11.

The incident identifier 51 includes: a number or symbol indicating a type of the incident (item A4) assigned to the vehicle 1, and a brief description of the incident. The incident identifier 51 has a format, for example, “38: Animal Troubles”, “45: Shooting”, etc. The region of the incident identifier 51 corresponding to a serious incident with a high-priority, such as an incident of gun or drug, may have a distinctive color (such as red) different from colors of other regions, and may blink. The number or symbol of the incident identifier 51, and the priority of the incident can be arbitrarily set for each police precinct.

The destination address 52 indicates the address of the scene of the incident.

The timer icon 49 indicates a remaining time of the timer until stopping the display of the incident identifier 51 and the destination address 52. This time is set to, for example, 10 seconds. This time can be set, for example, using a configuration file (for example, a file with an extension “.ini”) stored in the storage device 104 of the control apparatus 11. When the timer's timeout period expires, and the display of the incident identifier 51 and the destination address 52 is stopped, the incident identifier 51 and the destination address 52 may not be displayed again.

In addition, referring to the footer region 43, in the example of FIG. 12, the “L” button is set to notify the control apparatus 11 that the police officer 31 has confirmed the assignment of the incident to the vehicle 1, and the “R” button is set to stop the display of the incident identifier 51 and the destination address 52. When the “L” button is pressed, the control apparatus 11 transitions to the navigation mode.

When the voice commands are available, a voice command, such as “Confirmed”, may be used to notify the control apparatus 11 that the police officer 31 has confirmed the assignment of the incident to the vehicle 1. When the voice commands are available, a voice command, such as “Cancel” or “Ignore”, may be used to stop the display of the incident identifier 51 and the destination address 52.

In step S2, the control apparatus 11 may generate an alarm sound using the speaker 14, as well as display the incident identifier 51 and the destination address 52 on the display apparatus 13.

Again referring to FIG. 6, if the notification of step S2 has been confirmed by the police officer 31, then in step S3, the control apparatus 11 transitions to the navigation mode. Subsequently, in step S4, the control apparatus 11 displays, on the display apparatus 13, an image and/or text for directing a route from the current position of the vehicle 1 to the scene of the incident.

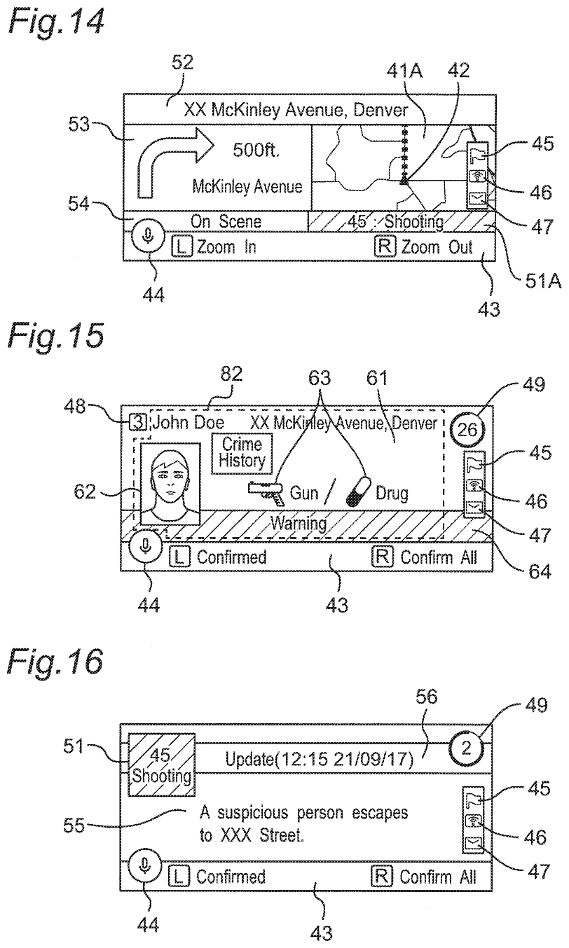

FIG. 13 is a diagram illustrating an exemplary image to be displayed on the display apparatus 13 of FIG. 1, when the control apparatus 11 of FIG. 1 is in the navigation mode and the vehicle 1 is moving to the scene of the incident. FIG. 14 is a diagram illustrating an exemplary image to be displayed on the display apparatus 13 of FIG. 1, when the control apparatus 11 of FIG. 1 is in the navigation mode and the vehicle 1 has arrived at the scene of the incident. In the states of FIGS. 13 and 14, the entire image to be displayed on the display apparatus 13 includes: a map 41A, the current position 42 of the vehicle 1, the footer region 43, the voice recognition icon 44, the flag icon 45, the wireless connection icon 46, the message icon 47, an incident identifier 51A, the destination address 52, a guide image and text 53, and a vehicle status 54.

The map 41A has a smaller size than the size of the map 41 of FIG. 11. On the map 41A, the route from the current position 42 of the vehicle 1 to the scene of the incident is illustrated (as a thick dotted line in the examples of FIGS. 13 and 14).

The incident identifier 51A includes: the number or symbol indicating the type of the incident assigned to the vehicle 1, and the brief description of the incident, in a manner similar to that of the incident identifier 51 of FIG. 12.

The guide image and text 53 include: an image indicating a direction of moving at a next intersection, and a text indicating a distance to the next intersection. By displaying such image and text, the route from the current position 42 of the vehicle 1 to the scene of the incident is directed.

The vehicle status 54 indicates whether the vehicle 1 is moving (responding) or has arrived at the scene of the incident.

As shown in FIG. 13, in the navigation mode, about a half or more of the entire screen of the display apparatus 13 is occupied by a region 81, indicating the guide image and text 53 and the map 41A. The region 81, including only particularly important information for the vehicle 1 to move from the current position to the scene of the incident, is displayed on most of the screen of the display apparatus 13. Therefore, the police officer 31 driving the vehicle 1 can quickly and easily recognize the route from the current position to the scene of the incident, while concentrating on driving of the vehicle 1. By directing the route to the scene of the incident using the guide image and text 53, the police officer 31 can concentrate on driving the vehicle 1, as compared to the case of referring to the map 41 of FIG. 11. Accordingly, the safety of the driving of the vehicle 1 is less likely to be threatened.

FIG. 13 shows the region 81 by a dotted line for explanation purpose, but this dotted line is actually not displayed on the screen of the display apparatus 13. In addition, the region 81 shown in FIG. 13 has an exemplary shape, and may have other shapes.

Again referring to FIG. 6, if the control apparatus 11 has received the person information as well as the incident information from the search hub apparatus 7, then in step S5, the control apparatus transitions to the person information mode. Subsequently, in step S6, the control apparatus 11 displays at least a part of the person information, on the display apparatus 13. Details of the person information mode will be described below. If the person information displayed in step S6 has been confirmed by the police officer 31, then in step S7, the control apparatus 11 returns to the navigation mode. Subsequently, in step S8, the control apparatus 11 again displays the image of FIG. 13 or FIG. 14 on the display apparatus 13.

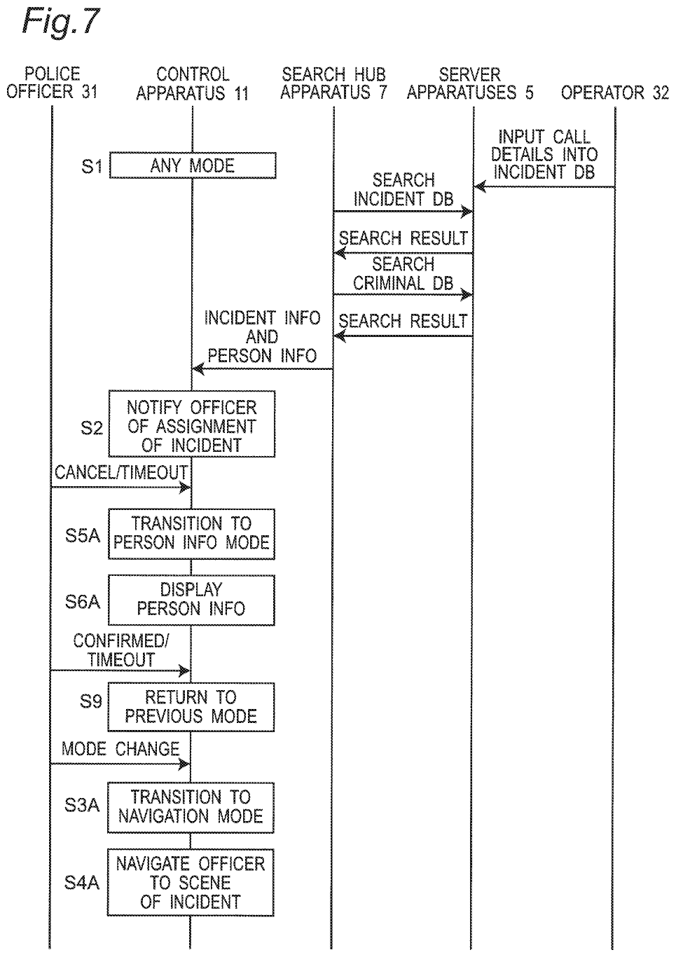

FIG. 7 is a sequence diagram illustrating another exemplary operation of the navigation system of FIG. 1, when an incident is assigned to the vehicle 1 of FIG. 1. Referring to FIG. 7, operations from the start to step S2 are the same as the corresponding operations of FIG. 6. If the control apparatus 11 has received the person information as well as the incident information from the search hub apparatus 7, then in step S2 and thereafter, the control apparatus 11 operates as follows.

If the notification of step S2 is canceled by the police officer 31 (for example, by pressing the “R” button, or speaking the voice command “Cancellation”), or if the timeout occurs without confirmation, then in step S5A, the control apparatus 11 transitions to the person information mode without transitioning to the navigation mode. Subsequently, in step S6A, the control apparatus 11 displays at least a part of the person information, on the display apparatus 13. If the person information of step S6A has been confirmed by the police officer 31, then in step S9, the control apparatus 11 returns to the previous mode of step S1.

If the control apparatus 11 has not received the person information from the search hub apparatus 7, then the control apparatus 11 keeps the mode of step S1 unchanged without executing steps S5A, S6A, and S9.

Thereafter, in a case where the control apparatus 11 is in the normal mode, if the “M” button is pressed or a voice command “Navigation” is spoken, then in step S3A, the control apparatus 11 transitions to the navigation mode. Subsequently, in step S4A, the control apparatus 11 displays the image and/or text for directing a route from the current position of the vehicle 1 to the scene of the incident, on the display apparatus 13, as shown in FIGS. 13 and 14, based on the incident information received from the search hub apparatus 7.

Referring to FIGS. 11 to 14, we have been described the case where the new incident is assigned to the vehicle 1 when the control apparatus 11 is in the normal mode. Meanwhile, in a case where the control apparatus 11 is in any of the other modes (the navigation mode, the vehicle search mode, or the person information mode), when a new incident is assigned to the vehicle 1, the control apparatus 11 also operates in a manner substantially similar to that of the case described with reference to FIGS. 6 and 7, and the screen of the display apparatus 13 changes in a manner substantially similar to that shown in FIGS. 11 to 14. That is, if the control apparatus 11 has received the incident information (or the incident information and the person information) from the search hub apparatus 7, then the timer icon 49, the incident identifier 51, and the destination address 52 of FIG. 12 are overlaid on the elements of the entire image of the display apparatus 13 in the mode before transition. Accordingly, the control apparatus 11 displays the message indicating that the incident is assigned to the vehicle 1, on the display apparatus 13 (step S2 of FIG. 6 or 7). Thereafter, when the police officer 31 has confirmed the assignment of the incident to the vehicle 1, the control apparatus 11 executes steps S3 to S8 of FIG. 6. Meanwhile, when the notification of step S2 is canceled by the police officer 31, or when the timeout occurs without confirmation, the control apparatus 11 executes steps S5A to S4A of FIG. 7.

[2-4. Person Information Mode]

FIG. 15 is a diagram illustrating an exemplary image to be displayed on the display apparatus 13 of FIG. 1, when the control apparatus 11 of FIG. 1 is in the person information mode. In the state of FIG. 15, the entire image to be displayed on the display apparatus 13 includes: the footer region 43, the voice recognition icon 44, the flag icon 45, the wireless connection icon 46, the message icon 47, the counter icon 48, the timer icon 49, and person information 61.

The person information 61 includes, for example, a name, a face photograph, an address, and a crime history of a person who is an ex-convict associated with the address of the scene of the incident. When a plurality of face photographs are stored in the criminal database of the server apparatus 5c, the latest face photograph 62 may be selected and displayed.

When the person related to the person information 61 has a previous criminal record related to a serious incident, for example, gun or drug incident, the person information 61 may include not only a text indicating details of the criminal record, but also a figure, such as an icon 63. In addition, when the person related to the person information 61 has a previous criminal record related to a serious incident, the person information 61 may further include a warning message 64 indicating that much attention needs to be paid to the person. A region of the warning message 64 may have a distinctive color (such as red) different from colors of other regions, or may blink. The police officer 31 can more quickly and easily understand the details of the previous criminal record of the person related to the person information 61, by changing an appearance of the information to be displayed, depending on a content of the information, for example, using the icon 63 and the warning message 64, etc.

When the person related to the person information 61 is wanted, the person information 61 may include an image and/or text indicating that the person is wanted.

The timer icon 49 indicates a remaining time of the timer until stopping the display of the person information 61. This time is set to, for example, 30 seconds. This time can be set, for example, using a configuration file (for example, a file with an extension “.ini”) stored in the storage device 104 of the control apparatus 11.

In addition, referring to the footer region 43, in the example of FIG. 15, the “L” button is set to notify the control apparatus 11 that the police officer 31 has confirmed the person information, and the “R” button is set to stop the display of all person information on a plurality of persons.

When the voice commands are available, a voice command, such as “Confirmed”, may be used to notify the control apparatus 11 that the police officer 31 has confirmed the person information. When the voice commands are available, a voice command, such as “Confirm All”, may be used to stop the display of all the person information on the plurality of persons.

When the control apparatus 11 has received the person information as well as the incident information from the search hub apparatus 7, the control apparatus may alternately display the image of FIG. 13 or 14 (the navigation mode of steps S3 to S4), and the image of FIG. 15 (the person information mode of steps S5 to S6 or steps S5A to S6A), at a predetermined cycle (for example, two seconds). When the police officer 31 has confirmed the person information (for example, when the “L” button is pressed), the display of the image of FIG. 15 is stopped.

As shown in FIG. 15, in the person information mode, a region indicating the name, the face photograph, the address, and the criminal record of the person occupies a half or more of the entire screen of the display apparatus 13. A region 82 including only particularly important information on the ex-convict associated with the address of the scene of the incident is displayed on most of the screen of the display apparatus 13. Therefore, the police officer 31 driving the vehicle 1 can quickly and easily recognize the information on the ex-convict, while concentrating on driving the vehicle 1. The police officer 31 can concentrate on driving the vehicle 1, and thus, the safety of the driving of the vehicle 1 is less likely to be threatened.

FIG. 15 shows the region 82 by a dotted line for explanation purpose, but this dotted line is actually not displayed on the screen of the display apparatus 13. In addition, the region 82 shown in FIG. 15 has an exemplary shape, and the region 82 may have other shapes.

[2-5. Delivery of Message]

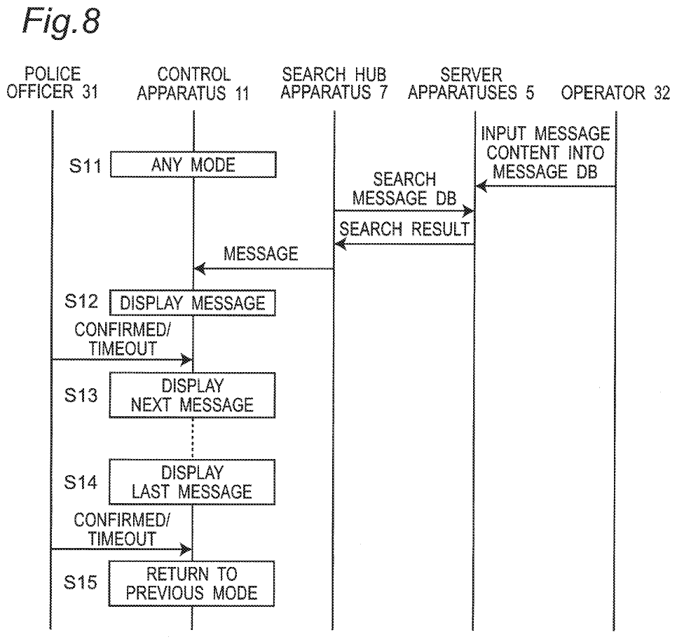

FIG. 8 is a sequence diagram illustrating an exemplary operation of the navigation system of FIG. 1, when the message destined for the vehicle 1 of FIG. 1 is inputted.

In step S11, the control apparatus 11 is in any mode of the normal mode, the navigation mode, the vehicle search mode, and the person information mode.

The operator 32 inputs a content of the message destined for a certain vehicle 1, into the message database of the server apparatus 5d.

The search hub apparatus 7 automatically and periodically (for example, every few seconds) searches the message database of the server apparatus 5d, and when one or more new messages has been inputted, receives a search result. The search hub apparatus 7 automatically and periodically transmits the searched message to the control apparatus 11 of the vehicle 1 of destination.

If one or a plurality of messages have received from the search hub apparatus 7, then in step S12 and thereafter, the control apparatus 11 displays the messages one by one on the display apparatus 13.

FIG. 16 is a diagram illustrating an exemplary image to be displayed on the display apparatus 13 of FIG. 1, when the control apparatus 11 of FIG. 1 is in the navigation mode and a message destined for the vehicle 1 is inputted. In the state of FIG. 16, the entire image to be displayed on the display apparatus 13 includes: the footer region 43, the voice recognition icon 44, the flag icon 45, the wireless connection icon 46, the message icon 47, the timer icon 49, the incident identifier 51, a message 55, and a timestamp 56.

The message 55 includes a content, for example, “A suspicious person escapes to XXX Street” or “The vehicle is in the median”, etc.

The timestamp 56 indicates a time at which the operator 32 inputted the message into the message database of the server apparatus 5d.

The timer icon 49 indicates a remaining time of the timer until stopping the display of the message 55. This time is set to, for example, 10 seconds. This time can be set, for example, using a configuration file (for example, a file with an extension “.ini”) stored in the storage device 104 of the control apparatus 11.

In addition, referring to the footer region 43, in the example of FIG. 12, the “L” button is set to notify the control apparatus 11 that the police officer 31 has confirmed the message, and the “R” button is set to stop the display of all the plurality of messages. If the “L” button is pressed, or if the timeout occurs without confirmation, then in steps S13 to S14, the control apparatus 11 displays the next un-displayed message on the display apparatus 13. For the last message, if the “L” button is pressed, or if the timeout occurs without confirmation, then in step S15, the control apparatus 11 returns to the previous mode of step S11.

When the voice commands are available, a voice command, such as “Confirmed”, may be used to notify the control apparatus 11 that the police officer 31 has confirmed the message. When the voice commands are available, a voice command, such as “Confirm All”, may be used to stop the display of all the plurality of messages.

[2-6. Cancellation of Assigned Incident]

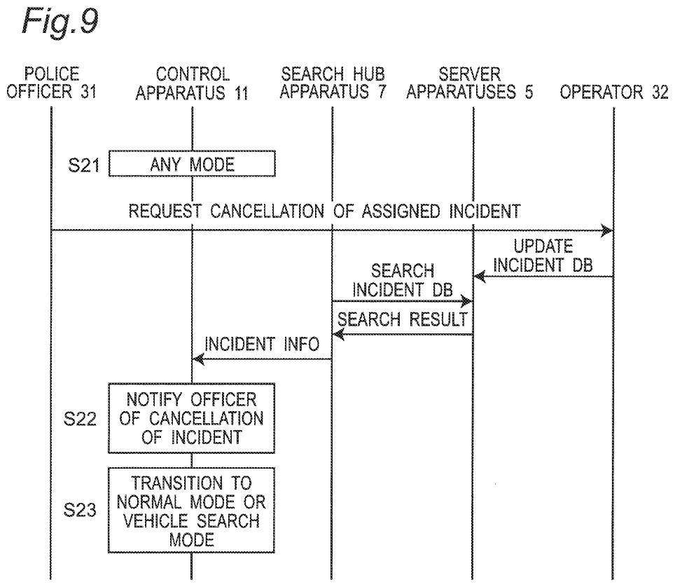

FIG. 9 is a sequence diagram illustrating an exemplary operation of the navigation system of FIG. 1, when cancelling an incident assigned to the vehicle 1 of FIG. 1.

In step S21, the control apparatus 11 is in any mode of the normal mode, the navigation mode, the vehicle search mode, and the person information mode.

When the message indicating that an incident is assigned to the vehicle 1 is displayed on the display apparatus 13 (step S2 of FIG. 6 or 7), the police officer 31 of the vehicle 1 determines whether or not to take over the incident. If the police officer 31 takes over the incident, then the process proceeds as described with reference to FIGS. 6 and 7. On the other hand, if the police officer 31 does not take over the incident, then the police officer 31 requests the operator 32 to cancel the assigned incident, by talking with the operator via the wireless communication apparatus 20 and the wireless communication apparatus 2.

The operator 32 updates the incident database of the server apparatus 5a so as to cancel the assignment of the incident to the vehicle 1. The operator 32 inputs another person(s) in charge (i.e., police officer(s) or vehicle) in the item A1 of the incident database, or leaves this item blank.

The search hub apparatus 7 searches the incident database of the server apparatus 5a, and receives the updated incident information, that is, a search result including incident information on the incident whose assignment to the vehicle 1 is canceled. The search hub apparatus 7 transmits the updated incident information to the control apparatus 11.

In step S22, when the updated incident information has been received from the search hub apparatus 7, the control apparatus 11 displays a message indicating that the assignment of the incident is cancelled, on the display apparatus 13.

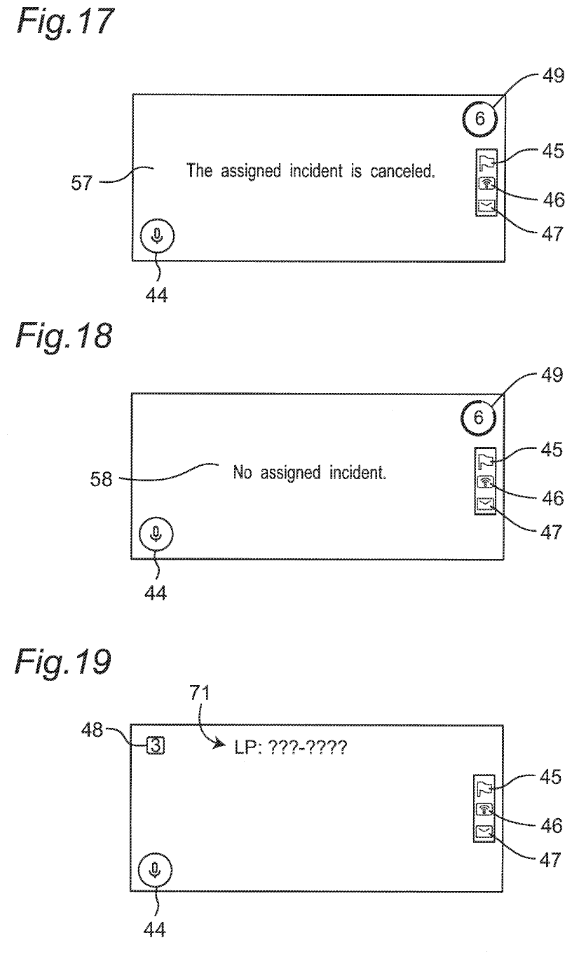

FIG. 17 is a diagram illustrating an exemplary image to be displayed on the display apparatus 13 of FIG. 1, when the incident assigned to the vehicle 1 is canceled. In the state of FIG. 17, the entire image to be displayed on the display apparatus 13 includes: the voice recognition icon 44, the flag icon 45, the wireless connection icon 46, the message icon 47, the timer icon 49, and a message 57.

Again referring to FIG. 9, the control apparatus 11 displays the notification of step S22, and then, waits until the timer's timeout occurs. Thereafter, in step S23, the control apparatus 11 transitions to the normal mode or the vehicle search mode.

Also in a case where the police officer 31 of the vehicle 1 takes over an incident, and the police officer 31 drives the vehicle 1 and arrives at the scene of the incident, the process of FIG. 9 is executed. In this case, in step S21, the control apparatus 11 is in the navigation mode, and in step S23, the control apparatus 11 transitions to the normal mode.

[2-7. Navigation Mode when No Incident is Assigned]

FIG. 18 is a diagram illustrating an exemplary image to be displayed on the display apparatus 13 of FIG. 1, when no incident is assigned to the vehicle 1. In the state of FIG. 18, the entire image to be displayed on the display apparatus 13 includes: the voice recognition icon 44, the flag icon 45, the wireless connection icon 46, the message icon 47, the timer icon 49, and a message 58.

In a case where the control apparatus 11 transitions to the navigation mode from the normal mode, the vehicle search mode, or the person information mode, when no incident is assigned to the vehicle 1, the control apparatus 11 displays the image of FIG. 18 on the display apparatus 13. Thereafter, when the timer's timeout occurs, the control apparatus 11 returns to the previous mode.

[2-8. Vehicle Search Mode]

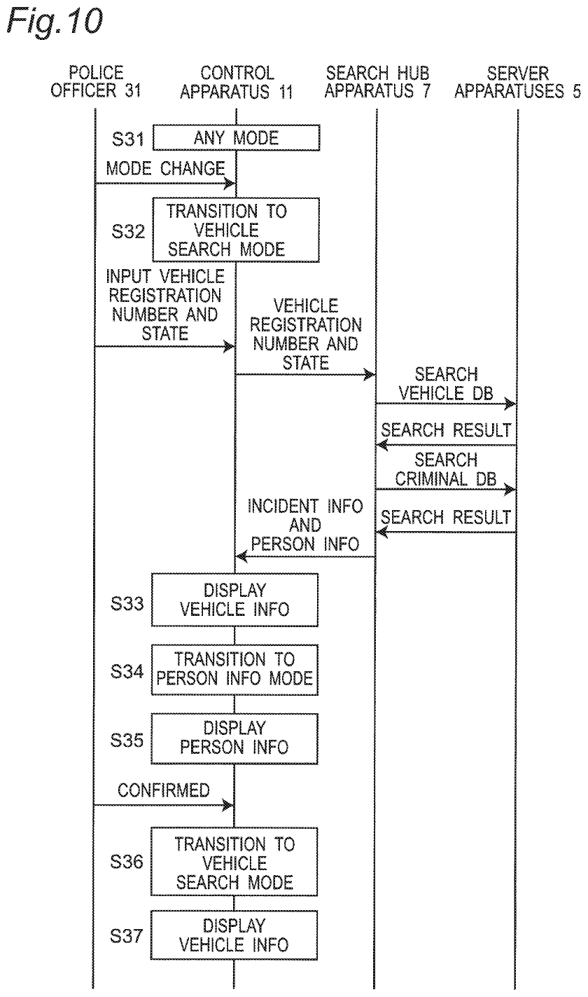

FIG. 10 is a sequence diagram illustrating an exemplary operation of the navigation system of FIG. 1, when searching for information on a target vehicle, in the vehicle 1 of FIG. 1.

In step S31, the control apparatus 11 is in any mode of the normal mode, the navigation mode, the vehicle search mode, and the person information mode.

The police officer 31 presses the “M” button, or speaks the voice command “Vehicle Search”. Accordingly, in step S32, the control apparatus 11 transitions to the vehicle search mode.

FIG. 19 is a diagram illustrating an exemplary image to be displayed on the display apparatus 13 of FIG. 1, when the control apparatus 11 of FIG. 1 is in the vehicle search mode and waits for the user input. In the state of FIG. 19, the entire image to be displayed on the display apparatus 13 includes: the voice recognition icon 44, the flag icon 45, the wireless connection icon 46, the message icon 47, the counter icon 48, and a search key 71. In the initial state of FIG. 19, the search key 71 is blank, or a set of any symbols (such as “?” and

Again referring to FIG. 10, then, the police officer 31 inputs a search key, such as a vehicle registration number of a certain target vehicle (for example, a suspicious vehicle found during patrol), for example, using a voice command “AAA-BBBB, Texas, search”. In Japan, the police officer 31 inputs the vehicle registration number. In United States, the police officer 31 inputs the vehicle registration number, and the name of state where the target vehicle is registered. In the example of the embodiment, the case of the United States will be described.

The control apparatus 11 recognizes the inputted vehicle registration number and state name using the voice recognition application 116, and transmits the recognized vehicle registration number and state name to the search hub apparatus 7.

The search hub apparatus 7 searches the vehicle database of the server apparatus 5b based on the vehicle registration number and the state name, and receives a search result including the vehicle information on the target vehicle. In addition, the search hub apparatus 7 automatically searches the criminal database of the server apparatus Sc based on the search result of the server apparatus 5b, that is, based on the owner's name of the target vehicle, and receives a search result including person information on an ex-convict who is the owner of the target vehicle. The search hub apparatus 7 transmits the vehicle information on the target vehicle, to the control apparatus 11 of the vehicle 1. The transmitted vehicle information may include only items B2, B3, and B5 to B11 to be displayed on the display apparatus 13 as described below, and may further include other items stored in the vehicle database. When there is the person information on the ex-convict who is the owner of the target vehicle, the search hub apparatus 7 transmits the person information as well as the incident information.

If the control apparatus 11 has received the vehicle information (or the vehicle information and the person information) from the search hub apparatus 7, then in step S33, the control apparatus 11 displays the vehicle information, on the display apparatus 13.

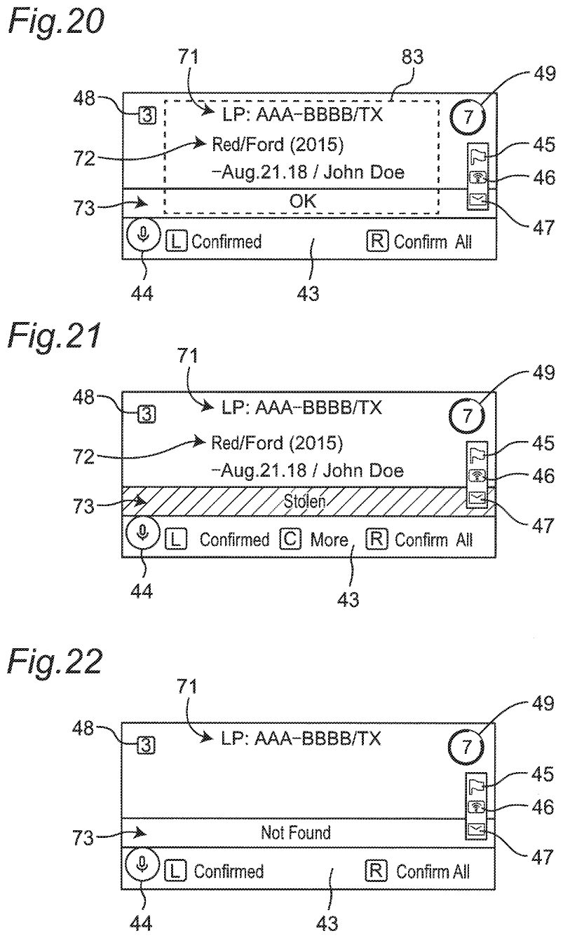

FIG. 20 illustrates an exemplary image to be displayed on the display apparatus 13 of FIG. 1, when the control apparatus 11 of FIG. 1 is in the vehicle search mode and indicates that the target vehicle corresponding to the search key is not stolen. In the state of FIG. 20, the entire image to be displayed on the display apparatus 13 includes: the footer region 43, the speech recognition icon 44, the flag icon 45, the wireless connection icon 46, the message icon 47, the counter icon 48, the timer icon 49, the search key 71, a search result 72, and a vehicle status 73.

In the state of FIG. 20, the search key 71 indicates the inputted vehicle registration number and state name.

The search result 72 includes: a color of the target vehicle (“red”), a manufacturer of the target vehicle (“Ford”), a model or a model year of the target vehicle (“2015”), and an update date of the registration information on the target vehicle (“-Aug. 21. 18” or August 21, 2018), and the owner of the target vehicle (“John Doe”).

The vehicle status 73 indicates whether or not the target vehicle is stolen. FIG. 20 illustrates a case where the target vehicle is not stolen. However, even though the status of the vehicle is not recorded as “Stolen” in the vehicle database of the server apparatus 5b, when there is a mismatch between the actual target vehicle and the vehicle information recorded in the vehicle database (for example, when the colors are different from each other), the police officer 31 conducts the necessary investigation.

In addition, referring to the footer region 43, in the example of FIG. 20, the “L” button is set to notify the control apparatus 11 that the police officer 31 has confirmed the vehicle information, and the “R” button is set to stop the display of all vehicle information on a plurality of target vehicles.

When the voice commands are available, a voice command, such as “Confirmed”, may be used to notify the control apparatus 11 that the police officer 31 has confirmed the vehicle information. When the voice commands are available, a voice command, such as “Confirm All”, may be used to cancel the display of all the vehicle information on the plurality of vehicles.

As shown in FIG. 20, in the vehicle search mode, a region 83 indicating the vehicle registration number, the owner of the target vehicle, the manufacturer of the target vehicle, the type of the target vehicle, the update date of the registration information on the target vehicle, the color of the target vehicle, and whether or not the target vehicle is stolen occupies a half or more of the entire screen of the display apparatus 13. The region 83 including only particularly important information on the target vehicle is displayed on most of the screen of the display apparatus 13. Therefore, the police officer 31 driving the vehicle 1 can quickly and easily recognize the information on the target vehicle, while concentrating on driving of the vehicle 1. The police officer 31 can concentrate on driving the vehicle 1, and thus, the safety of the driving of the vehicle 1 is less likely to be threatened.

FIG. 20 shows the region 83 by a dotted line for explanation purpose, but this dotted line is actually not displayed on the screen of the display apparatus 13. In addition, the region 83 shown in FIG. 20 has an exemplary shape, and the region 83 may have other shapes.

FIG. 21 is an exemplary image to be displayed on the display apparatus 13 of FIG. 1, when the control apparatus 11 of FIG. 1 is in the vehicle search mode and indicates that the target vehicle corresponding to the search key is stolen. In the state of FIG. 21, the vehicle status 73 indicates that the target vehicle is stolen. In this case, a region of the vehicle status 73 may have a distinctive color (such as red) different from colors of other regions, or may blink.

In addition to displaying in the region of the vehicle status 73 that the target vehicle is stolen, the control apparatus 11 may generate an alarm sound using the speaker 14.

In addition, referring to the footer region 43, in the example of FIG. 21, the “L” button and the “R” button are set in a manner similar to that of the case of FIG. 20, and the “C” button is set to display other information (for example, any of the items B 1 to B 11 stored in the vehicle database) on the target vehicle being stolen.

When the voice commands are available, a voice command, such as “More”, may be used to display other information on the target vehicle being stolen.

FIG. 22 is a diagram illustrating an exemplary image to be displayed on the display apparatus 13 of FIG. 1, when the control apparatus 11 of FIG. 1 is in the vehicle search mode and there is no target vehicle corresponding to the search key.

Again referring to FIG. 10, if the control apparatus 11 receives the person information as well as the incident information from the search hub apparatus 7, then in step S34, the control apparatus 11 transitions to the person information mode. Subsequently, in step S35, the control apparatus 11 displays at least a part of the person information, on the display apparatus 13.

In step S35, the control apparatus 11 operates in a manner similar to that of the case of step S6 of FIG. 6. If the person information of step S35 has been confirmed by the police officer 31, then in step S36, the control apparatus 11 returns to the vehicle search mode. Subsequently, in step S37, the control apparatus 11 again displays the vehicle information, on the display apparatus 13.

When the control apparatus 11 receives the person information as well as the vehicle information from the search hub apparatus 7, the control apparatus may alternately display the image of FIGS. 20 to 22 (navigation mode), and the image of FIG. 15 (person information mode), at a predetermined cycle (for example, 2 seconds). When the police officer 31 has confirmed the person information (for example, when the “L” button is pressed), the display of the images of FIG. 15 is stopped.

[2-9. On-Scene Process]

When the vehicle 1 has arrived at a location within a predetermined range of the destination, the control apparatus 11 may change the contents to be mainly displayed on the display apparatus 13, based on information obtained from various databases, such as the incident database, the vehicle database, the criminal database, and the message database. For example, the control apparatus 11 may mainly display the image of the navigation mode until arriving at the destination, and mainly display information on crimes when arriving near the destination.

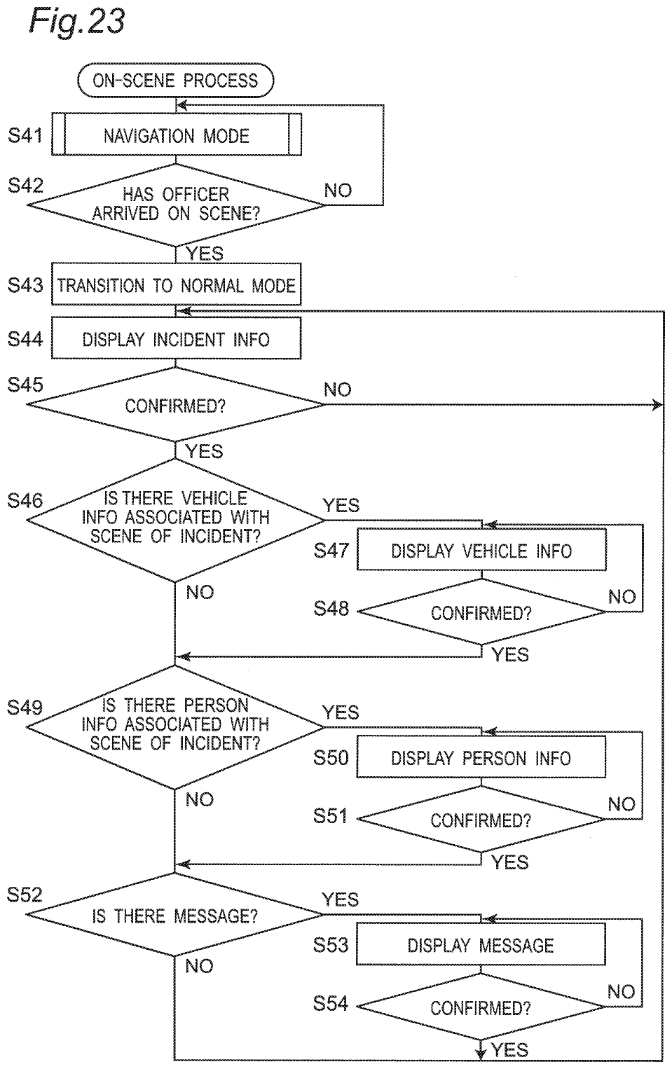

FIG. 23 is a flowchart illustrating an on-scene process to be executed by the control apparatus 11, when the vehicle 1 of FIG. 1 has arrived at the scene of the incident.

In step S41, the control apparatus 11 is in the navigation mode. In step S42, the control apparatus 11 determines whether or not the vehicle 1 has arrived at the scene of the incident, based on the GPS signals received by the GPS receiver 18; if YES, the process proceeds to step S43; and if NO, the process repeats step S41. When the vehicle 1 has arrived at the scene of the incident and has stopped, the control apparatus 11 may determine that the vehicle 1 has arrived at the scene of the incident. Alternatively, when the distance from the current position of the vehicle 1 to the scene of the incident is equal to or less than a predetermined threshold, or when the vehicle 1 has passed through the last intersection on the route to the scene of the incident, the control apparatus 11 may determine that the vehicle 1 has arrived at the scene of the incident. In step S43, the control apparatus 11 transitions to the normal mode.

In step S44, the control apparatus 11 displays all or part of the incident information received from the search hub apparatus 7, on the display apparatus 13. When the police officer 31 has confirmed the displayed incident information, the police officer 31 presses any of the buttons on the keypad 17 indicating confirmation (for example, “L” button), or speaks the voice command “Confirmed”. In step S45, the control apparatus 11 determines whether or not the incident information has been confirmed by the police officer 31; if YES, the process proceeds to step S46; and if NO, the process proceeds to step S44.

In step S46, the control apparatus 11 determines whether or not there is vehicle information associated with the scene of the incident, if YES, the process proceeds to step S47; and if NO, the process proceeds to step S49. In step S47, the control apparatus 11 displays all or part of the vehicle information received from the search hub apparatus 7, on the display apparatus 13. When the police officer 31 has confirmed the displayed vehicle information, the police officer 31 presses any of the buttons on the keypad 17 indicating confirmation (for example, “L” button), or speaks the voice command “Confirmed”. In step S48, the control apparatus 11 determines whether or not the vehicle information has been confirmed by the police officer 31, if YES, the process proceeds to step S49; and if NO, the process returns to step S47.

Suppose a case where there is vehicle information on a plurality of vehicles associated with the scene of the incident. In such a case, when the police officer 31 has confirmed vehicle information on a certain vehicle, the control apparatus 11 may display vehicle information on a next vehicle, on the display apparatus 13, and when the police officer 31 has confirmed the vehicle information on all the vehicles, the control apparatus 11 may proceed to step S49.

In step S49, the control apparatus 11 determines whether or not there is person information associated with the scene of the incident, if YES, the process proceeds to step S50; and if NO, the process proceeds to step S52. In step S50, the control apparatus 11 displays all or a part of the person information received from the search hub apparatus 7, on the display apparatus 13. When the police officer 31 has confirmed the displayed person information, the police officer 31 presses any of the buttons on the keypad 17 indicating confirmation (for example, “L” button), or speaks the voice command “Confirmed”. In step S51, the control apparatus 11 determines whether or not the person information has been confirmed by the police officer 31, if YES, the process proceeds to step S52; and if NO, the process returns to step S50.

Suppose a case where there is person information on a plurality of persons associated with the scene of the incident. In such a case, when the police officer 31 has confirmed person information on a certain person, the control apparatus 11 may display person information on a next person, on the display apparatus 13, and when the police officer 31 has confirmed the person information on all the persons, the control apparatus 11 may proceed to step S52.

In step S52, the control apparatus 11 determines whether or not there is a message, if YES, the process proceeds to step S53; and if NO, the process returns to step S44. In step S53, the control apparatus 11 displays the message on the display apparatus 13. When the police officer 31 has confirmed the displayed message, the police officer 31 presses any of the buttons on the keypad 17 indicating confirmation (for example, “L” button), or speaks the voice command “Confirmed”. In step S54, the control apparatus 11 determines whether or not the message has been confirmed by the police officer 31, if YES, the process returns to step S44; and if NO, the process returns to step S53.

Suppose a case where there is a plurality of messages. In such a case, when the police officer 31 has confirmed a certain message, the control apparatus 11 may display a next message on the display apparatus 13, and when the police officer 31 has confirmed all the messages, the control apparatus 11 may proceed to S44.

In the example of FIG. 23, the information is displayed on the display apparatus 13 in the order of “incident information->vehicle information->person information->message->incident information-> . . . ”, but may be displayed in other orders.

By performing the on-scene process of FIG. 23, the police officer 31 can safely drive the vehicle 1 to the scene of the incident, and after the arrival on the scene, can quickly obtain information necessary for services.

[2-10. Summary of Operations]

The police officer 31 can cause the control apparatus 11 to transition among the normal mode, the navigation mode, and the vehicle search mode, using the “M” button or the voice commands.

When the control apparatus 11 is in a mode different from the navigation mode, and a new incident is assigned to the vehicle 1 in the incident database of the server apparatus 5a, the control apparatus 11 indicates that the new incident is assigned to the vehicle 1, on the display apparatus 13, as shown in FIG. 12. Also in a case where the control apparatus 11 is in the navigation mode, when a new incident is assigned to the vehicle 1 in the incident database of the server apparatus 5a, the control apparatus 11 indicates that the new incident is assigned to the vehicle 1, on the display apparatus 13. Accordingly, the police officer 31 causes the control apparatus 11 to transition to the navigation mode, using the “M” button or the voice commands.

In the vehicle search mode, the police officer 31 can search for and display the vehicle information on the target vehicle, using only the voice commands.

In the navigation mode, when the person associated with the address of the scene of the incident exists, and is recorded in the criminal database, the control apparatus 11 transitions to the person information mode, in which the information on the person is displayed on the display apparatus 13. In addition, in the vehicle search mode, when the person who is the owner of the target vehicle is recorded in the criminal database, the control apparatus 11 transitions to the person information mode, in which the information on the person is displayed on the display apparatus 13. As described above, the control apparatus 11 can access a plurality of databases with simple operation, by accessing one of the plurality of databases, and based on an access result, accessing another one of the plurality of databases.

As described above, the police officer 31 can obtain the route from the current position to the scene of the incident, and search for and browse other information on the incident, with simple operation using the keypad 17 and the voice commands. An easily-operable user interface is provided for searching for the vehicle information. The person information is automatically searched for and displayed, based on the incident information and the vehicle information.

In addition, as described with reference to FIGS. 13, 15, and 20, in the navigation mode, the person information mode, and the vehicle search mode, most of the screen of the display apparatus 13 is used to display only important information for the services of the police officer 31. Accordingly, the police officer 31 easily recognizes the contents of the entire image, and the safety of the driving is less likely to be threatened. In addition, the operation can be simplified as described above by reducing the number of items to be displayed on the display apparatus 13.

It is possible to present information on main services of the police officer 31, while providing a sufficient visual field for the police officer 31 driving the vehicle 1, for example, using the head-up display as the display apparatus 13.

As described above, according to the present embodiment, it is possible to provide a safe and efficient control apparatus 11, navigation system, and program.

As shown in FIG. 11 and the like, when there is an incident(s) being assigned to the vehicle 1 and having not been processed, the counter icon 48 is displayed. When handling of a certain incident is completed, the assignment of the completed incident is canceled as described with reference to FIG. 9. Subsequently, the control apparatus 11 automatically transitions to the navigation mode, and directs a route to the scene at which the next incident occurs.

Referring to FIGS. 6 to 8, we have described the case where the search hub apparatus 7 automatically and periodically transmits the search results of the incident database and the message database to the control apparatus 11. Alternatively, the control apparatus 11 may periodically query the search hub apparatus 7 about new incidents and/or new messages.

[3. Advantageous Effects, Etc.]

The information processing apparatus according to the first embodiment has the following configurations and advantageous effects.

The information processing apparatus according to the first embodiment is provided with the control apparatus 11 accessible the plurality of databases, and the control apparatus 11 accesses one of the plurality of databases, and based on an access result, accesses another one of the plurality of databases.

Accordingly, the control apparatus 11 can access and search a certain database, and then based on a search result, automatically access and search another database, for example, via the search hub apparatus 7. Accordingly, it is possible to efficiently search for and obtain highly relevant information being distributed over the plurality of databases. In addition, the user can more safely drive the vehicle by automatically and efficiently collecting the related information.

The information processing apparatus according to the first embodiment may be mounted on the vehicle 1. The information processing apparatus may be further provided with: the WAN communication apparatus 19 that accesses a first database of the plurality of databases, the first database storing the information on crimes; the display apparatus 13 that displays at least a part of the information obtained from the first database, and the control apparatus 11 that controls the WAN communication apparatus 19 and the display apparatus 13. When displaying at least the part of the information obtained from the first database on the display apparatus 13, the control apparatus 11 changes the appearance of the information to be displayed, depending on a content of the information.

Accordingly, by changing the appearance of the information to be displayed, depending on the content of the information, the user can more quickly and easily understand, for example, details of a previous criminal record of a certain person.

The information processing apparatus according to the first embodiment may be further provided with the GPS receiver 18 that obtains the information on the current position of the vehicle 1. When the vehicle 1 has arrived at a location within a predetermined range of a destination, the control apparatus 11 may change the contents to be displayed on the display unit, based on information obtained from the plurality of databases.

Accordingly, the user can safely drive the vehicle 1 to a destination, and after the arrival on the destination, quickly obtain information necessary for services.

The information processing apparatus according to the first embodiment is provided with: a WAN communication apparatus 19 that accesses a plurality of external databases, a control apparatus 11 that obtains information from the external databases via the WAN communication apparatus 19, and a display apparatus 13 that displays the information obtained by the control apparatus 11. The WAN communication apparatus 19, the control apparatus 11, and the display apparatus 13 are mounted on the vehicle 1. The display apparatus 13 displays the information within a visual field of a driver of the vehicle 1.

Accordingly, it is possible to present the information on the main services of the user, while providing a sufficient visual field for the user driving the vehicle 1.

In addition, the control apparatus, the navigation system, and the program according to the first embodiment have the following configurations and advantageous effects.

The control apparatus according to the embodiment is communicatively connected to at least one server apparatus 5a to 5d, and is connected to the display apparatus 13. The at least one server apparatus includes a first server apparatus that stores information on a plurality of tasks each associated with a destination. The control apparatus 11 has a first mode and a second mode; in the first mode, the control apparatus 11 displays, on the display apparatus 13, an image and/or text for directing a route from a current position of the control apparatus 11 to the destination associated with the task assigned to the control apparatus 11 in the first server apparatus; and in the second mode, the control apparatus 11 displays a search result searched based on a search key, on the display apparatus 13. The control apparatus 11 transitions between the first and second modes based on user inputs. When the control apparatus 11 is in a mode different from the first mode, and in the first server apparatus, a new task is assigned to the control apparatus 11, the control apparatus 11 indicates on the display apparatus 13 that the new task is assigned to the control apparatus 11.

Accordingly, with simple operation, it is possible to direct the user from the current position to the destination associated with a certain task, and search and browse other information on the task.

In accordance with the control apparatus according to the embodiment, in the first mode, a region indicating the image, the text, and/or a map for directing the route from the current position of the control apparatus 11 to the destination may occupy a half or more of an entire screen of the display apparatus 13.

Accordingly, the driver of the vehicle 1 can quickly and easily recognize the route from the current position to the destination, while concentrating on driving the vehicle 1, and thus, the safety of the driving of the vehicle 1 is less likely to be threatened.

In accordance with the control apparatus according to the embodiment, when a person associated with an address of the destination exists and satisfies predetermined conditions, the control apparatus 11 may transition to a third mode in which the control apparatus 11 displays the information on the person, on the display apparatus 13.

Accordingly, other information on the task can be automatically searched for and displayed.

In accordance with the control apparatus according to the embodiment, the search key may be a vehicle registration number. In the second mode, the control apparatus 11 displays information on a target vehicle associated with the vehicle registration number, on the display apparatus 13.

Accordingly, a user interface for easily searching for other information on the task is provided.

In accordance with the control apparatus according to the embodiment, in the second mode, a region indicating the vehicle registration number, an owner of the target vehicle, a manufacturer of the target vehicle, a type of the target vehicle, an update date of registration information on the target vehicle, a color of the target vehicle, and whether or not the target vehicle is stolen may occupy a half or more of an entire screen of the display apparatus 13.

Accordingly, the driver of the vehicle 1 can quickly and easily recognize information on the target vehicle, while concentrating on driving the vehicle 1, and thus, the safety of the driving of the vehicle 1 is less likely to be threatened.

In accordance with the control apparatus according to the embodiment, when a person who is an owner of the target vehicle satisfies predetermined conditions, the control apparatus 11 may transition to the third mode in which the control apparatus 11 displays information on the person, on the display apparatus 13.

Accordingly, other information on the task can be automatically searched for and displayed.

In accordance with the control apparatus according to the embodiment, in the third mode, a region indicating a name, a face photograph, an address, and a crime history of the person may occupy a half or more of an entire screen of the display apparatus 13.

Accordingly, the driver of the vehicle 1 can quickly and easily recognize information on the person, while concentrating on the driving the vehicle 1, and thus, the safety of the driving of the vehicle 1 is less likely to be threatened.

In accordance with the control apparatus according to the embodiment, the control apparatus 11 may receive the search key and user inputs inputted by voice.

Accordingly, with simple operation using voice commands, it is possible to direct the user from the current position to the destination associated with a certain task, and search and browse other information on the task.

In accordance with the control apparatus according to the embodiment, the control apparatus 11 may further have a fourth mode in which the control apparatus 11 displays a map indicating the current position of the control apparatus 11, on the display apparatus 13. The control apparatus 11 transitions among the first, second, and fourth modes, based on user inputs.

Accordingly, with simple operation, it is possible to direct the user from the current position to the destination associated with a certain task, and search and browse other information on the task.

The navigation system according to the embodiment includes: the control apparatus 11, the first server apparatus that stores the information on the plurality of tasks each associated with a destination, and a second server apparatus that stores information on a plurality of vehicles, and a third server apparatus that stores information on a plurality of persons.

Accordingly, with simple operation, it is possible to direct the user from the current position to the destination associated with a certain task, and search and browse other information on the task.

In accordance with the navigation system according to the embodiment, the control apparatus 11 may be mounted on the vehicle 1. The display apparatus 13 may be disposed on the vehicle 1 so as to occupy a predetermined angular range or less of a visual field in front of a driver of the vehicle 1.

Accordingly, it is possible to present the information on services of the driver, while providing a sufficient visual field for the driver of the vehicle 1.

In accordance with the navigation system according to the embodiment, the navigation system may further include a search hub apparatus that is communicatively connected to the control apparatus 11 and the first to third server apparatuses, searches for the information stored in the first to third server apparatuses, and transmits search results to the control apparatus 11.

Accordingly, it is possible to reduce the amount of communication among the control apparatus 11 and the first to third server apparatuses.

The program according to the embodiment is executed by a computer that is communicatively connected to at least one server apparatus and operates as the control apparatus 11 connected to the display apparatus 13. At least one server apparatus 5a to 5d includes a first server apparatus that stores information on a plurality of tasks each associated with a destinations. The program includes, in a first mode, a step of displaying, on the display apparatus 13, an image and/or text for directing a route from a current position of the control apparatus 11 to the destination associated with the task assigned to the control apparatus 11 in the first server apparatus. The program includes, in a second mode, a step of displaying, on the display apparatus 13, a search result searched based on a search key. The program includes a step of transitioning between the first and second modes based on user inputs. When the control apparatus 11 is in a mode different from the first mode, and in the first server apparatus, a new task is assigned to the control apparatus 11, the program includes a step of displaying on the display apparatus 13 that the new task is assigned to the control apparatus 11.

Accordingly, with simple operation, it is possible to direct the user from the current position to the destination associated with a certain task, and search and browse other information on the task.

### Second Embodiment

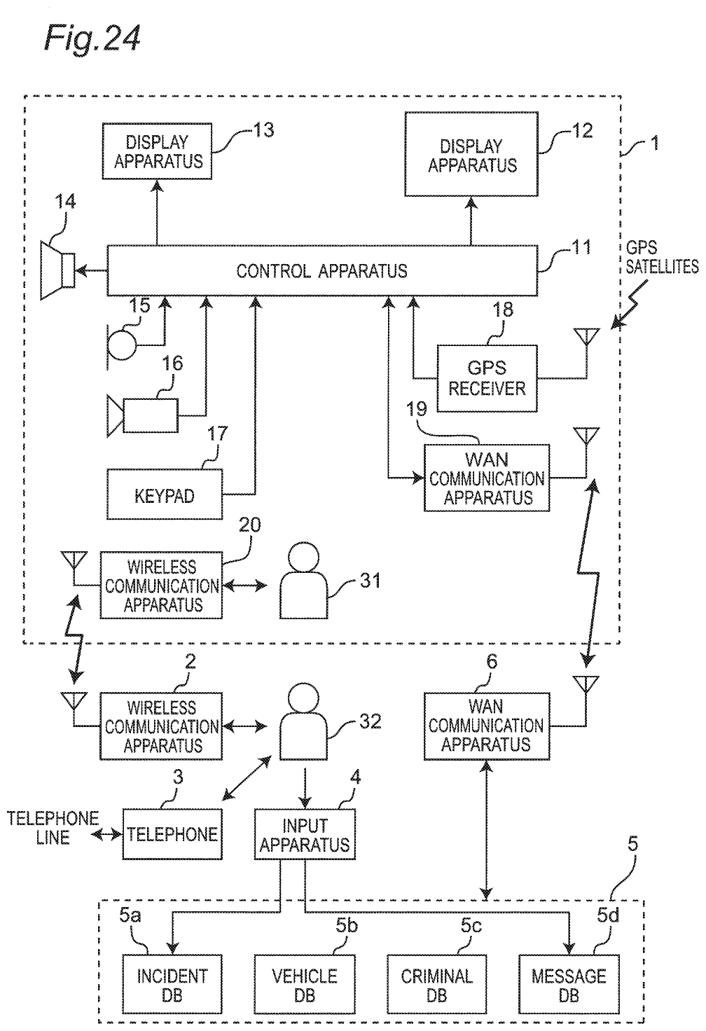

FIG. 24 is a block diagram illustrating a configuration of a navigation system including an information processing apparatus according to a second embodiment. The control apparatus 11 may directly access the server apparatuses 5a to 5d, without using the search hub apparatus 7 of FIG. 1.

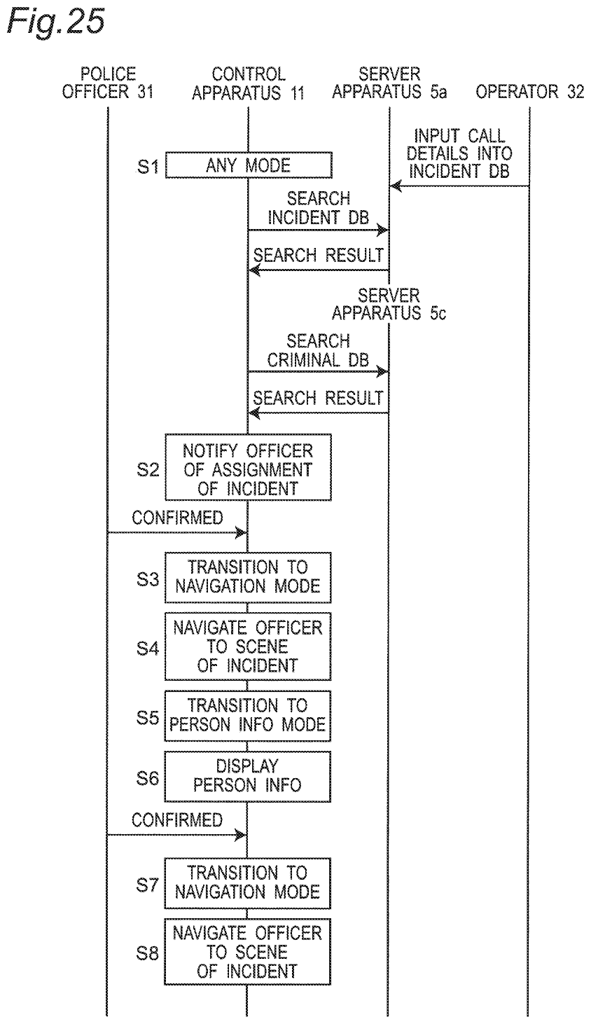

FIG. 25 is a sequence diagram illustrating an exemplary operation of the navigation system of FIG. 24, when an incident is assigned to the vehicle 1 of FIG. 24. The control apparatus 11 automatically and periodically searches the incident database of the server apparatus 5a, and when a new incident has been inputted, receives a search result. In addition, the control apparatus 11 automatically searches the criminal database of the server apparatus Sc based on the search result of the server apparatus 5a, that is, an address of a scene at which the new incident has occurred, and receives a search result including person information on a person associated with this address. Subsequent operations of the control apparatus 11 are performed in a manner similar to that described with reference to FIG. 6.

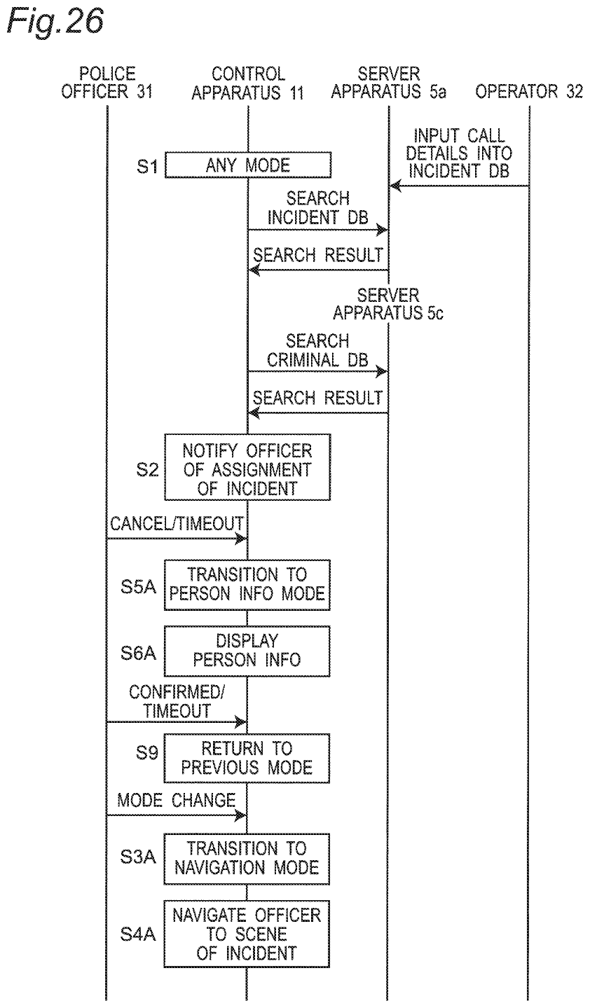

FIG. 26 is a sequence diagram illustrating another exemplary operation of the navigation system of FIG. 24, when an incident is assigned to the vehicle 1 of FIG. 24. In a manner similar to that of the case of FIG. 25, the control apparatus 11 searches the incident database of the server apparatus 5a to receive a search result, and searches the criminal database of the server apparatus Sc to receive a search result. Subsequent operations of the control apparatus 11 are performed in a manner similar to that described with reference to FIG. 7.

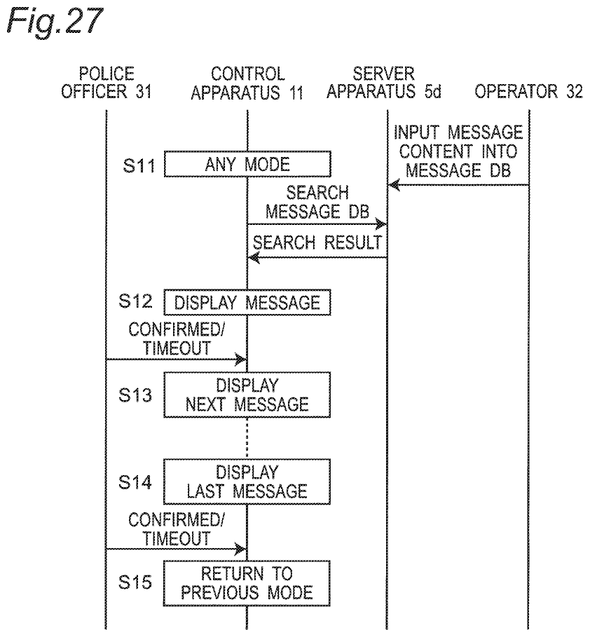

FIG. 27 is a sequence diagram illustrating an exemplary operation of the navigation system of FIG. 24, when a message destined for the vehicle 1 of FIG. 24 is inputted. The control apparatus 11 automatically and periodically searches the message database of the server apparatus 5d, and when one or more new messages has been inputted, receives a search result. Subsequent operations of the control apparatus 11 are performed in a manner similar to that described with reference to FIG. 8.

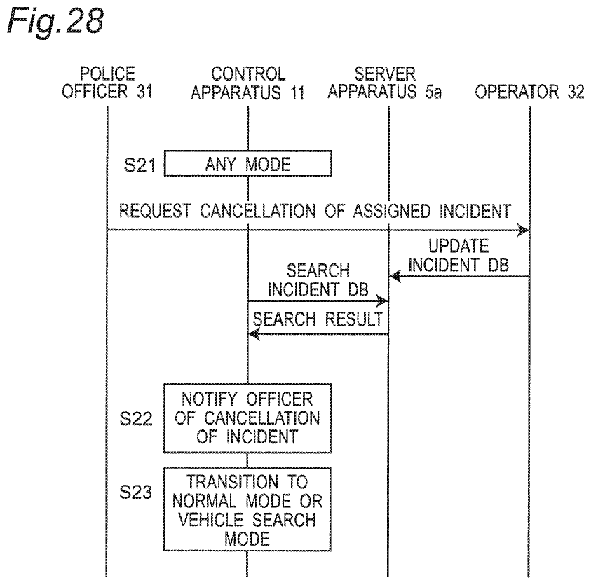

FIG. 28 is a sequence diagram illustrating an exemplary operation of the navigation system of FIG. 24, when cancelling an incident assigned to the vehicle 1 of FIG. 24. The control apparatus 11 searches the incident database of the server apparatus 5a, and receives updated incident information, that is, a search result including incident information on the incident whose assignment to the vehicle 1 is canceled. Subsequent operations of the control apparatus 11 are performed in a manner similar to that described with reference to FIG. 9.

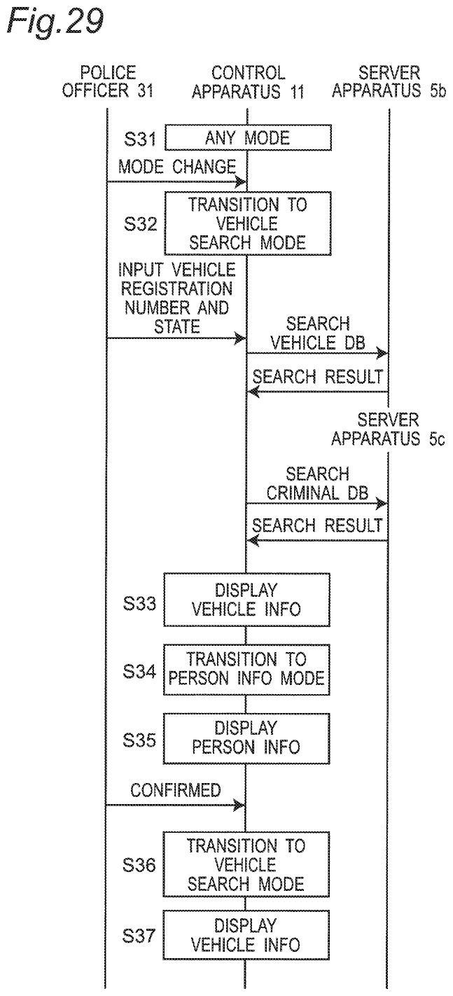

FIG. 29 is a sequence diagram illustrating an exemplary operation of the navigation system of FIG. 24, when searching for information on a target vehicle, in the vehicle 1 of FIG. 24. The control apparatus 11 searches the vehicle database of the server apparatus 5b based on a vehicle registration number and a state name, and receives a search result including vehicle information on a target vehicle. In addition, the control apparatus 11 automatically searches the criminal database of the server apparatus 5c based on the search result of the server apparatus 5b, that is, the owner's name of the target vehicle, and receives a search result including person information on an ex-convict who is the owner of the target vehicle. Subsequent operations of the control apparatus 11 are performed in a manner similar to that described with reference to FIG. 10.

As described above, the information processing apparatus according to the second embodiment is also provided with the control apparatus 11 that accesses the plurality of databases, and the control apparatus 11 accesses one of the plurality of databases, and based on an access result, accesses another one of the plurality of databases.

Accordingly, the control apparatus 11 can access and search a certain database, and then based on a search result, automatically access and search another database. Accordingly, it is possible to efficiently search for and obtain highly relevant information being distributed over the plurality of databases. In addition, the user can more safely drive the vehicle by automatically and efficiently collecting the related information.

### Other Embodiments

As described above, the embodiments have been described as examples of the technology of the present disclosure. However, the technology of the present disclosure is not limited thereto, and can be applied to embodiments with some change, replacement, addition, omission, etc. In addition, new embodiments can be derived by combining the components described in the aforementioned embodiments.

In the navigation mode, other information stored in the incident database, for example, details on an incident may be displayed on the display apparatus 13. Referring to FIGS. 13 and 14, for example, the “C” button may be set to display the details on the incident, on the display apparatus 13. In addition, in the person information mode, other information stored in the person database may be displayed on the display apparatus 13. Referring to FIG. 15, for example, the “C” button may be set to display other information on a person, on the display apparatus 13. In addition, in the vehicle search mode, not only when a target vehicle is stolen (FIG. 21), but also when the target vehicle is not stolen (FIG. 20), other information stored in the vehicle database may be displayed on the display apparatus 13.

In the navigation mode, when the guide image and text 53 is displayed as shown in FIGS. 13 and 14, the map 41A may be omitted. Accordingly, the police officer 31 can concentrate on driving the vehicle 1 as compared with the case where the map 41A is displayed, and thus, the safety of the driving of the vehicle 1 is less likely to be threatened.

When a status of the vehicle 1 changes (that is, whether or not an incident is assigned, whether the vehicle is moving to or has arrived at the destination), the control apparatus 11 may display a message indicating that the change occurs, on the display apparatus 13. In addition, the message database of the server apparatus 5d may store a priority associated with each message. The control apparatus 11 may display a message having a higher priority than a predetermined threshold, on the display apparatus 13.

In the vehicle search mode, the voice recognition of the vehicle registration number or the like may be performed by the server apparatus communicatively connected to the search hub apparatus 7 or by the search hub apparatus 7 itself, instead of being performed by the control apparatus 11.

In the vehicle search mode, the control apparatus 11 may recognize a vehicle registration number or the like of a target vehicle around the vehicle 1, by analyzing an image captured using the camera 16, instead of inputting the vehicle registration number or the like using voice commands. The control apparatus 11 transmits the vehicle registration number and the like recognized by the image analysis, to the search hub apparatus 7, and subsequent operations are performed in a manner similar to that of the case of inputting the vehicle registration number and the like using the voice commands.

The control apparatus 11 may display a search result of any database that can be searched based on a predetermined search key, instead of the vehicle database, on the display apparatus 13.

The control apparatus 11 may record logs of all inputs, all mode transitions, and all events in the control apparatus 11. The logs may be recorded in, for example, a Comma Separated Value (CSV) file having a file name “log YYYYMMDD.csv”. The logs may be locally recorded on the control apparatus 11, or may be recorded on a remote server apparatus. A location for recording the logs can be set, for example, using a configuration file (for example, a file with an extension “.ini”) stored in the storage device 104 of the control apparatus 11.

When the control apparatus 11 is in any mode, the control apparatus 11 may terminate the navigation application 117.

The control apparatus 11 may further have, for example, the following optional features:
inputting and uploading of reports related to incidents;
transmitting and receiving e-mails;
Internet browsing;
displaying current positions of all vehicles 1 in a police precinct (displaying in list or map);
displaying information on traffic controls and traffic violations; and
creating reports on drivers who are cleared for traffic violations.

The control apparatus 11 may change the contents to be displayed on the display apparatus 13, based on the status of the vehicle 1 and/or the weather, etc. When the vehicle 1 stops or is moving at a low speed, or when the weather is fine or clear, the control apparatus 11 may display contents including a large amount of information, such as the map 41 of FIG. 11, on the display apparatus 13. On the other hand, when the vehicle 1 is moving at a high speed, or when the weather is bad, such as raining, windy, or foggy, the control apparatus 11 may display simple contents, such as the guide image and text 53 of FIG. 12, on the display apparatus 13.

The control apparatus 11 may change the operations of the display apparatuses 12 and 13, based on the status of the vehicle 1 and/or the weather. When the vehicle 1 stops, the control apparatus 11 may operate both the display apparatuses 12 and 13, or may turn on only the display apparatus 12 and turn off the display apparatus 13. When the vehicle is moving at a typical speed, or when the weather is bad, such as raining, windy, or foggy, the control apparatus 11 may operate both the display apparatuses 12 and 13, or may turn on only the display apparatus 13 and may turn off the display apparatus 12. When the vehicle is moving at a very high speed, or when the vehicle is in dangerous situations, such as storms, lightning, or earthquakes, the control apparatus 11 may turn off both the display apparatuses 12 and 13.

The control apparatus 11 may control the display apparatuses 12 and 13, based on the status of the driver and other passengers of the vehicle 1. When a passenger other than the driver of the vehicle 1 is struggling, or when the driver of the vehicle 1 and other passengers do not move at all for a long time, the control apparatus 11 may blink the display apparatuses 12 and 13, and generate an alarm sound from the speaker 14. When a passenger other than the driver of the vehicle 1 is struggling, or when the driver of the vehicle 1 and other passengers do not move at all for a long time, the control apparatus 11 may turn off the display apparatuses 12 and 13. The user may set whether to blink the display apparatuses 12 and 13 and generate the alarm sound from the speaker 14, or to turn off the display apparatuses 12 and 13.

When the display apparatus 13 has an HDMI input terminal, the control apparatus 11 operates as follows. When an HDMI cable or connector of the display apparatus 13 is disconnected, the navigation application 117 is terminated. When the HDMI cable or connector of the display apparatus 13 is connected again, the navigation application 117 is automatically restarted. In this case, the display apparatus 13 displays the same image as that displayed before the termination.

In the examples of the embodiments described above, the vehicle 1 is a four-wheeled vehicle. However, the vehicle 1 may be a motorcycle (two-wheeled vehicle), or may be a vehicle having more than four wheels.

In the examples of the embodiments described above, one control apparatus 11 is provided for each vehicle 1. However, a plurality of police officers may board one vehicle 1, and each police officer may have the control apparatus 11.

The components of the vehicle 1 of FIG. 1 or 24, including at least the control apparatus 11, are not limited to be provided as the vehicle 1, but may be provided as, a wearable computer used by a police officer or other persons. Also in this case, the wearable information processing apparatus can access and search a certain database, and then based on a search result, automatically access and search another database. Accordingly, it is possible to efficiently search for and obtain highly relevant information being distributed over the plurality of databases. For example, the wearable information processing apparatus can direct the police officer wearing the apparatus from the current position to the destination associated with a certain task, and can search for and browse other information on the task, with simple operation.

The information processing apparatus according to the present disclosure is applicable to, for example, a police vehicle or a police officer.

1. An information processing apparatus accessible to a plurality of databases,
wherein the information processing apparatus accesses one of the plurality of databases, and based on an access result, accesses another one of the plurality of databases.

2. The information processing apparatus as claimed in claim 1,
wherein the information processing apparatus is mounted on a vehicle,
wherein the information processing apparatus further comprises:
a communication unit that accesses a first database of the plurality of databases, the first database storing information on crimes,
a display unit that displays at least a part of the information obtained from the first database, and
a control unit that controls the communication unit and the display unit, and
wherein, when displaying at least the part of the information obtained from the first database on the display unit, the control unit changes an appearance of the information to be displayed, depending on a content of the information.

3. The information processing apparatus as claimed in claim 2, further comprising: a positioning unit that obtains information on a current position of the vehicle,
wherein, when the vehicle has arrived at a location within a predetermined range of a destination, the control unit changes contents to be displayed on the display unit, based on information obtained from the plurality of databases.

4. An information processing apparatus comprising:
a communication unit that accesses a plurality of external databases;
a control unit that obtains information from the external databases through the communication unit; and
a display unit that displays the information obtained by the control unit,
wherein the communication unit, the control unit, and the display unit are mounted on a vehicle, and
wherein the display unit displays the information within a visual field of a driver of the vehicle.
